(19) United States
(12) Patent Application Publication
(10) Pub. No.: US 2026/0223227 A1
(43) Pub. Date: Jul. 30, 2026

(54) Multiple Access Network Configuration

(71) Applicant: Ofinno, LLC, Reston, VA (US)

(72) Inventors: SungDuck Chun, Fairfax, VA (US); Peyman Talebi Fard, Vienna, VA (US); Esmael Hejazi Dinan, McLean, VA (US); Kyungmin Park, Vienna, VA (US); Henrik Andreas Normann, Malmö (SE); Stanislav Filin, Chantilly, VA (US); Jian Xu, McLean, VA (US)

(73) Assignee: Ofinno, LLC, Reston, VA (US)

(21) Appl. No.: 19/573,475

(22) Filed: Mar. 20, 2026

Related U.S. Application Data
(63) Continuation of application No. PCT/US2024/047529, filed on Sep. 19, 2024.
(60) Provisional application No. 63/539,933, filed on Sep. 22, 2023.

(51) Int. Cl. H04W 76/15

(52) U.S. Cl. CPC H04W 76/15

(57) ABSTRACT

A core network node receives, from a policy control node, one or more policy session messages including one or more conditions for triggering a first policy session message. A condition of the one or more conditions includes that at least one 3rd generation partnership project (3GPP) access path, of a plurality of 3GPP access paths, changes. Based on the receiving, the core network node sends, to the policy control node, the first policy session message indicating a 3GPP access path, of the plurality of 3GPP access paths for a wireless device supporting dualsteer.

### CROSS-REFERENCE TO RELATED APPLICATIONS

This application is a continuation of International Application No. PCT/US2024/047529, filed Sep. 19, 2024, which claims the benefit of U.S. Provisional Application No. 63/539,933, filed Sep. 22, 2023, all of which are hereby incorporated by reference in their entireties.

### BRIEF DESCRIPTION OF THE DRAWINGS

Examples of several of the various embodiments of the present disclosure are described herein with reference to the drawings

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15A is a diagram of an aspect of an example embodiment of the present disclosure.

FIG. 15B is a diagram of an aspect of an example embodiment of the present disclosure.

FIG. 16 is a diagram of an aspect of an example embodiment of the present disclosure.

FIG. 17 is a diagram of an aspect of an example embodiment of the present disclosure.

FIG. 18 is a diagram of an aspect of an example embodiment of the present disclosure.

FIG. 19 is a diagram of an aspect of an example embodiment of the present disclosure.

FIG. 20 is a diagram of an aspect of an example embodiment of the present disclosure.

FIG. 21 is a diagram of an aspect of an example embodiment of the present disclosure.

FIG. 22 is a diagram of an aspect of an example embodiment of the present disclosure.

FIG. 23 is a diagram of an aspect of an example embodiment of the present disclosure.

FIG. 24 is a diagram of an aspect of an example embodiment of the present disclosure.

FIG. 25 is a diagram of an aspect of an example embodiment of the present disclosure.

FIG. 26 is a diagram of an aspect of an example embodiment of the present disclosure.

FIG. 27 is a diagram of an aspect of an example embodiment of the present disclosure.

FIG. 28 is a diagram of an aspect of an example embodiment of the present disclosure.

FIG. 29 is a diagram of an aspect of an example embodiment of the present disclosure.

FIG. 30 is a diagram of an aspect of an example embodiment of the present disclosure.

FIG. 31 is a diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

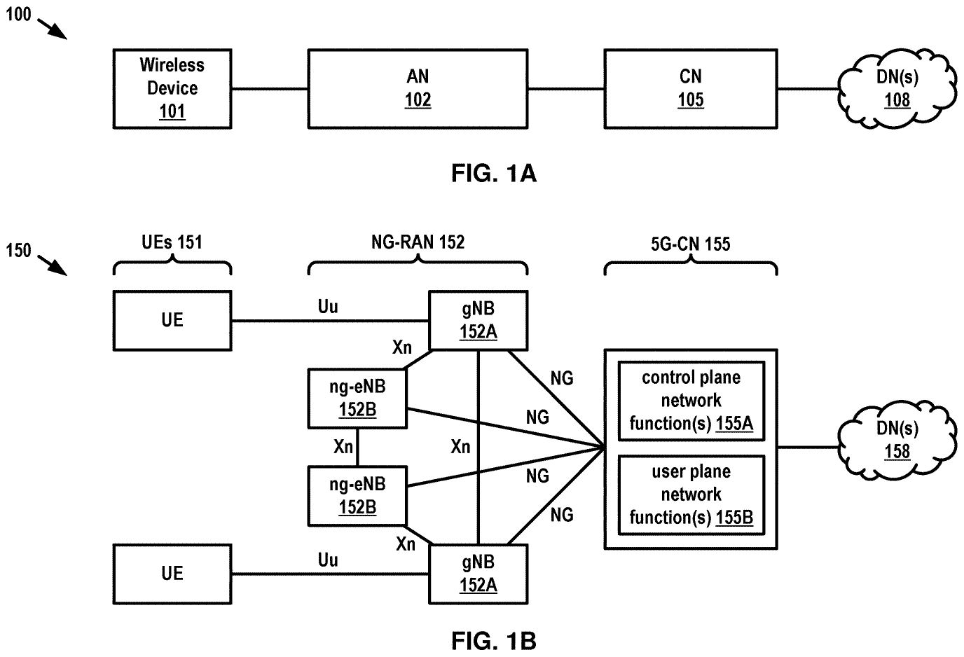

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

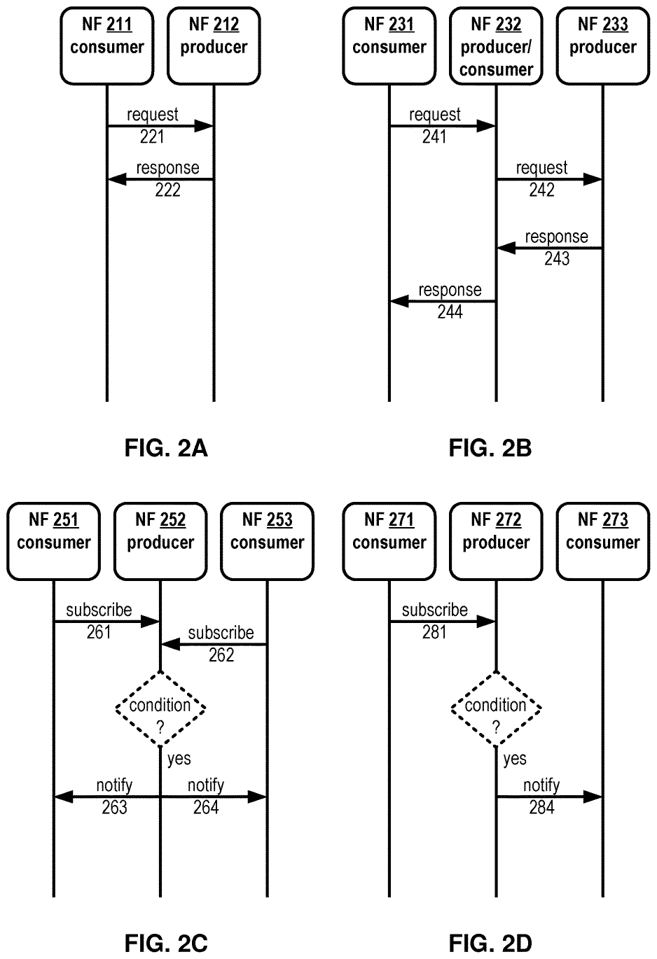

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such a service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

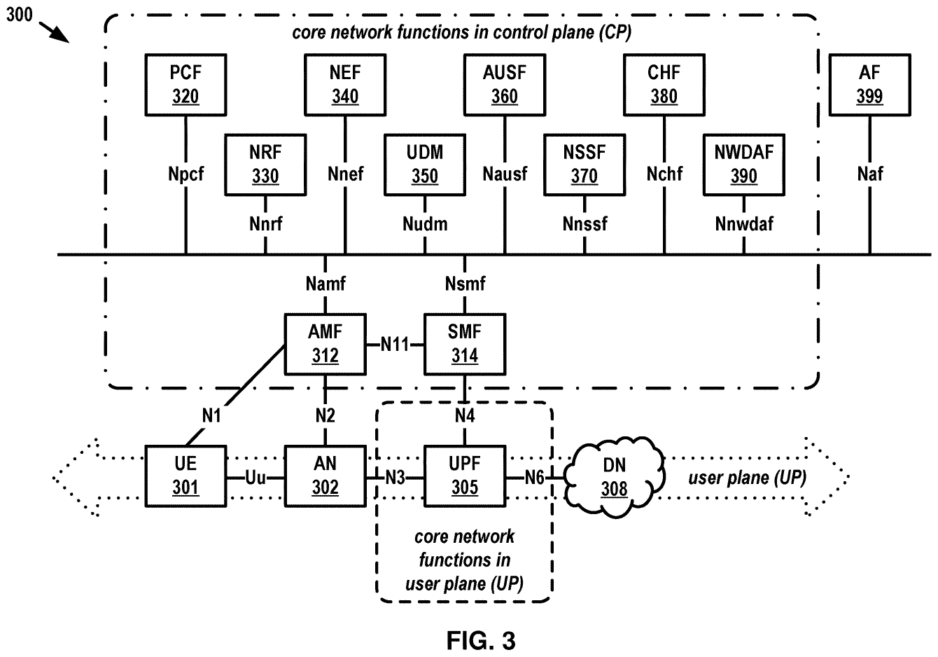

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC 220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

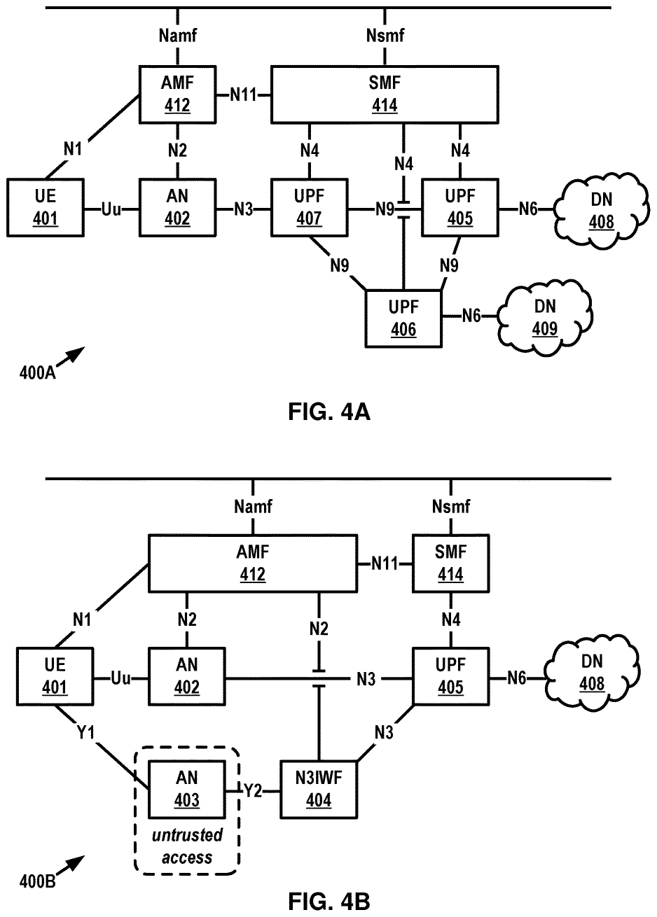

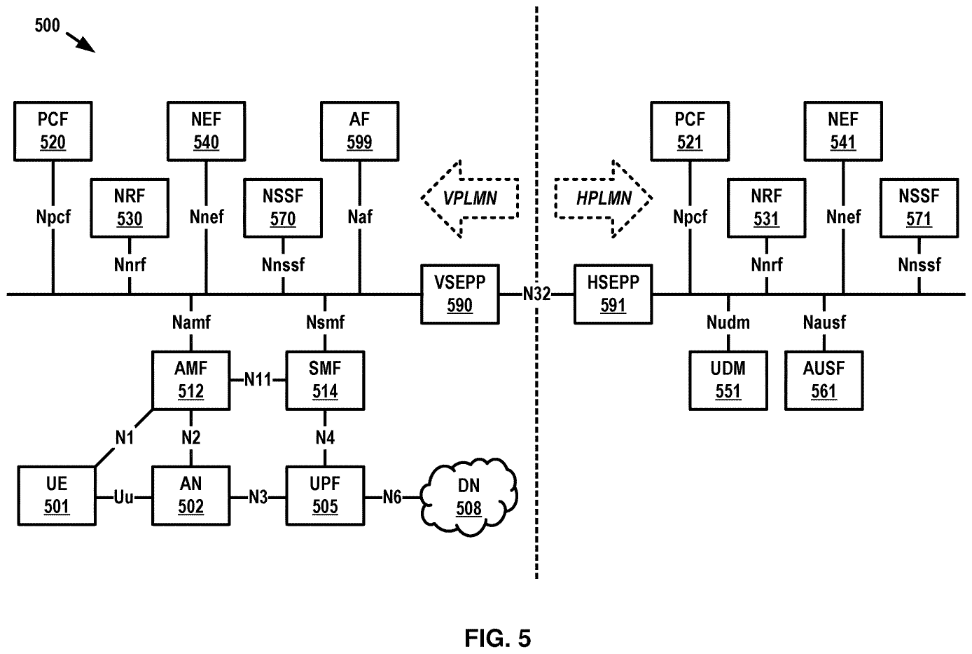

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number of downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4A) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

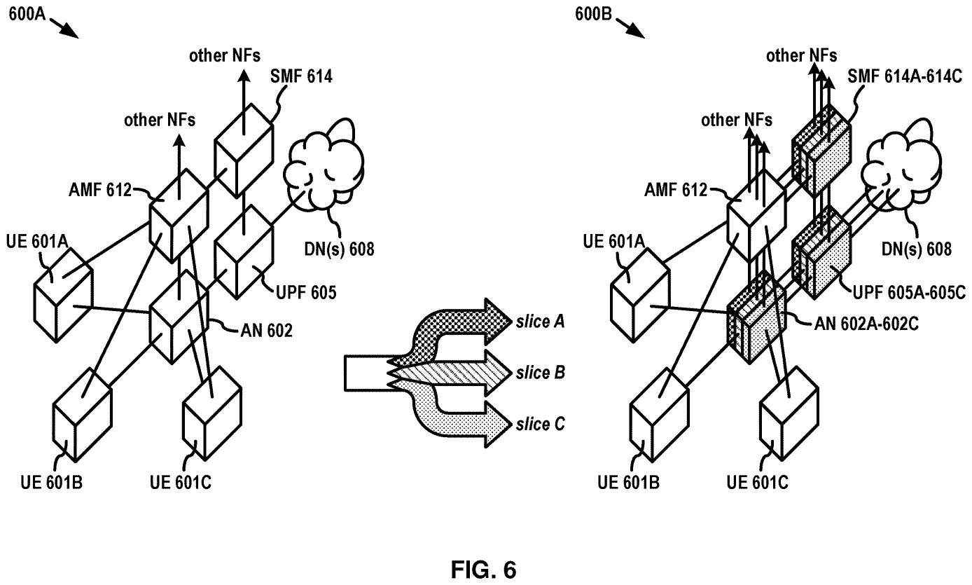

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). As an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

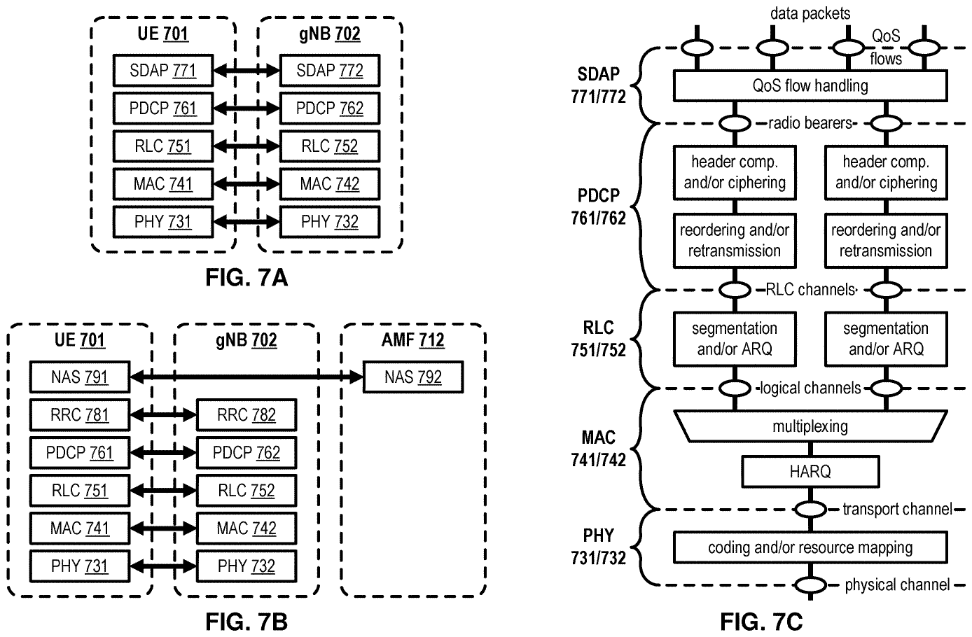

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

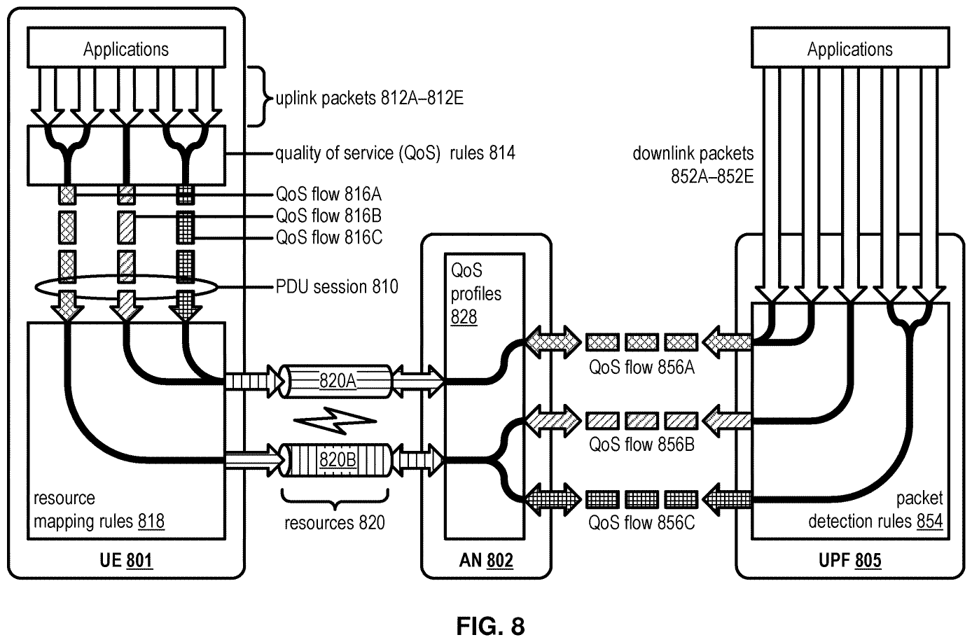

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which has one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

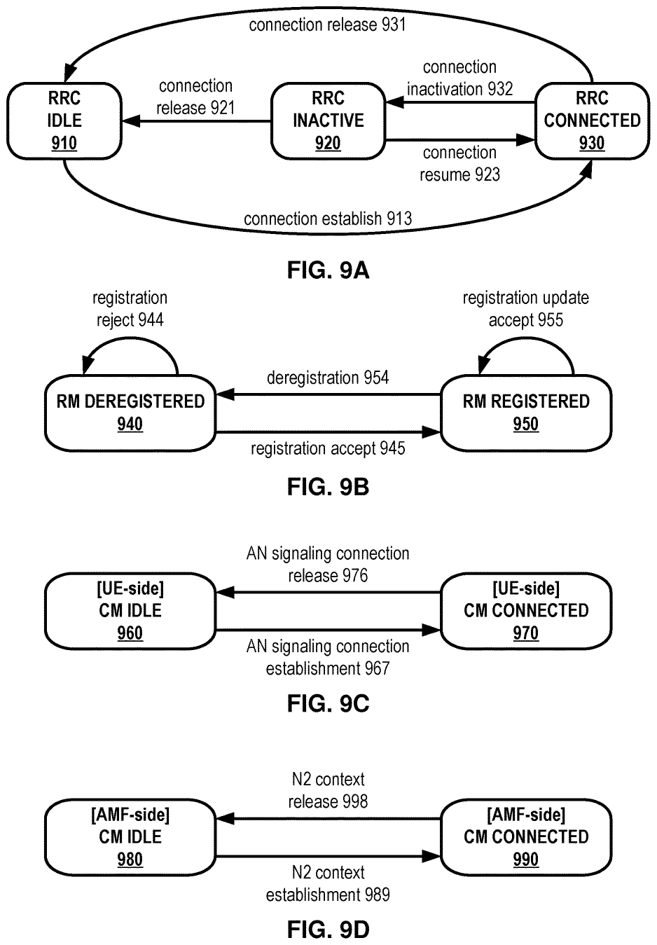

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary, use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE cannot communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF may release the N2 context of the UE (N2 context release 998).

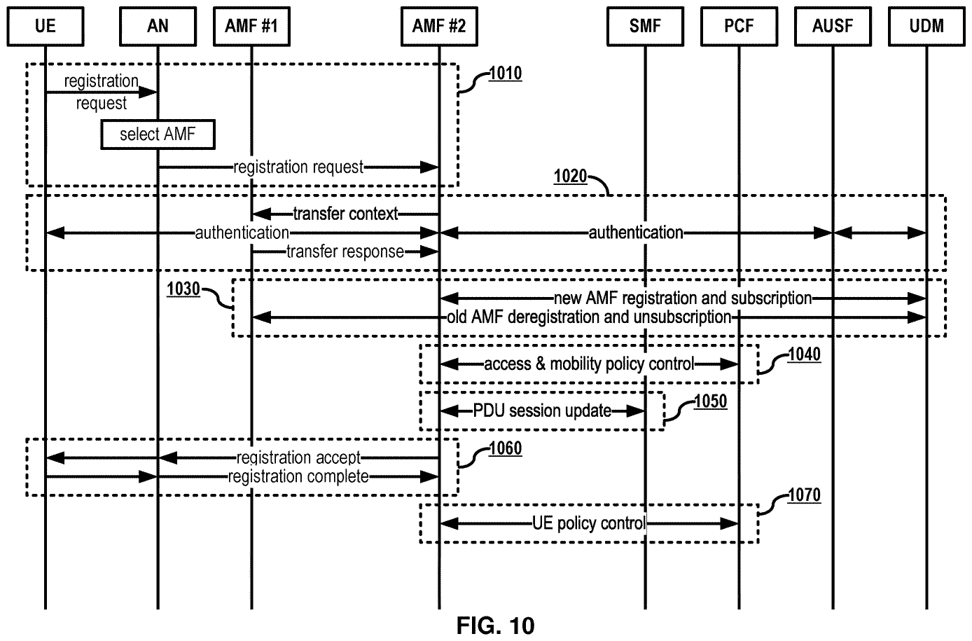

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

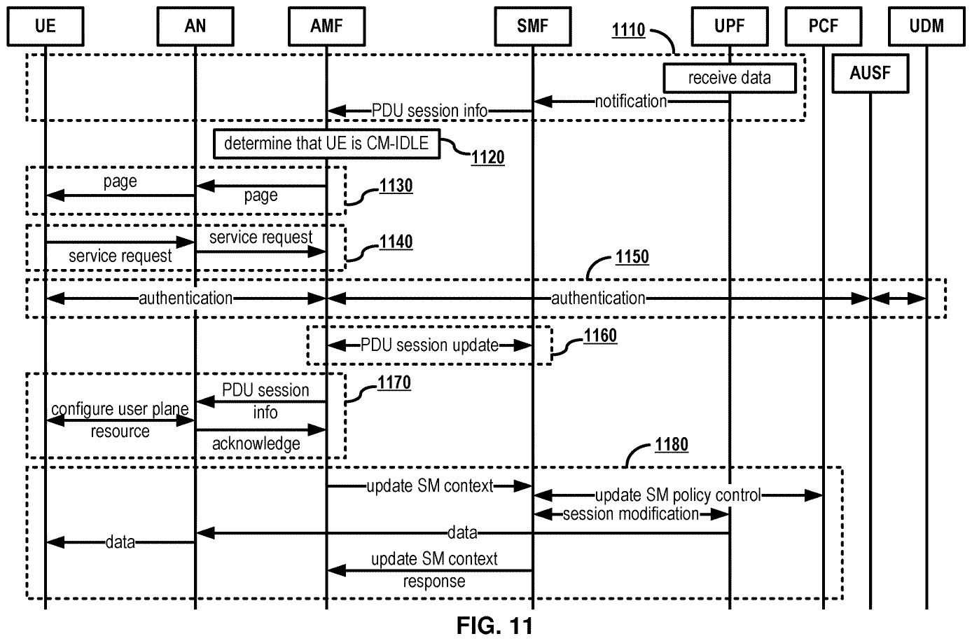

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

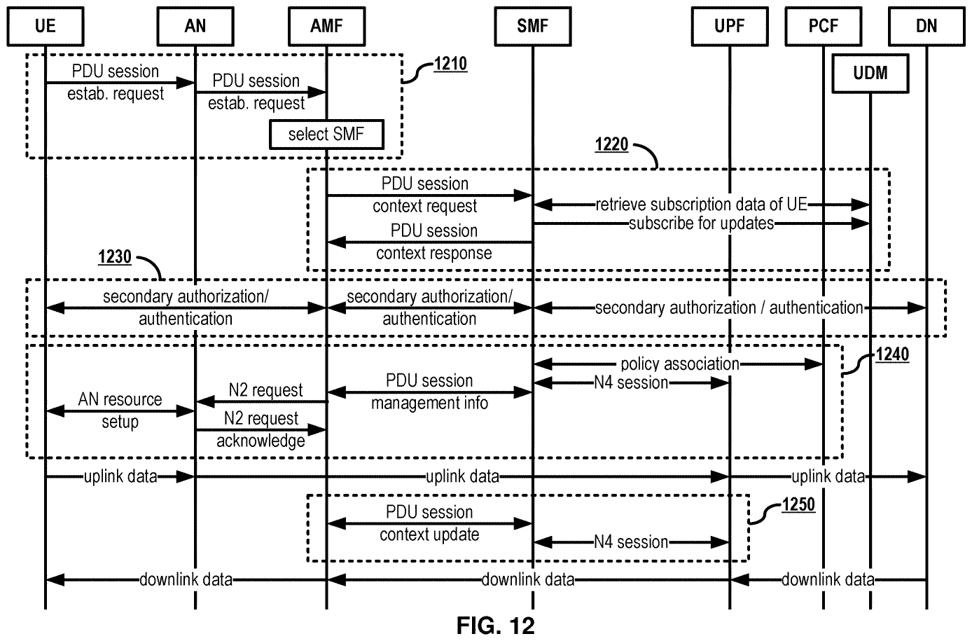

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a session service request (e.g., Namf_Communication_N1N2MessageTransfer) message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

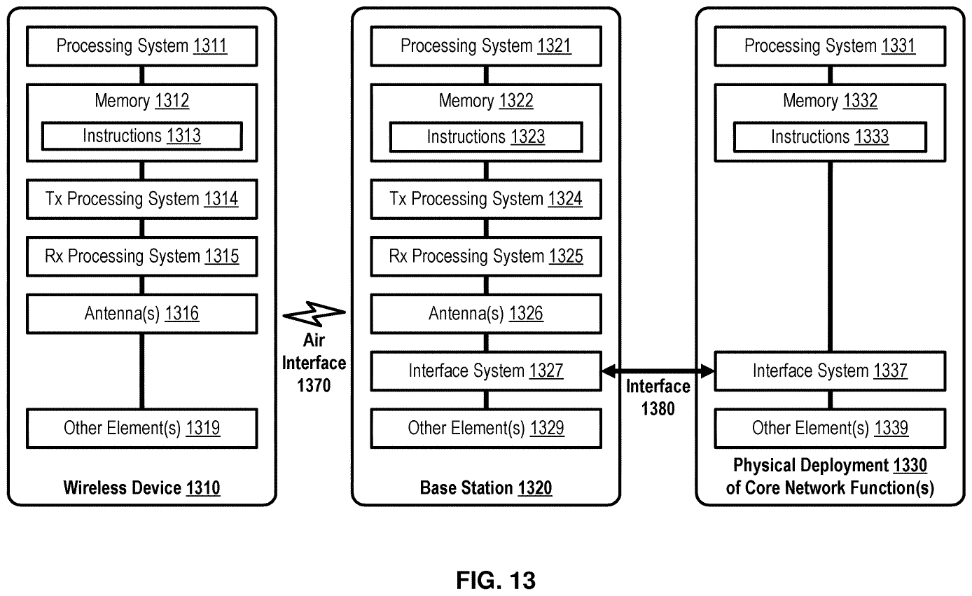

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab and/or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++ and/or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

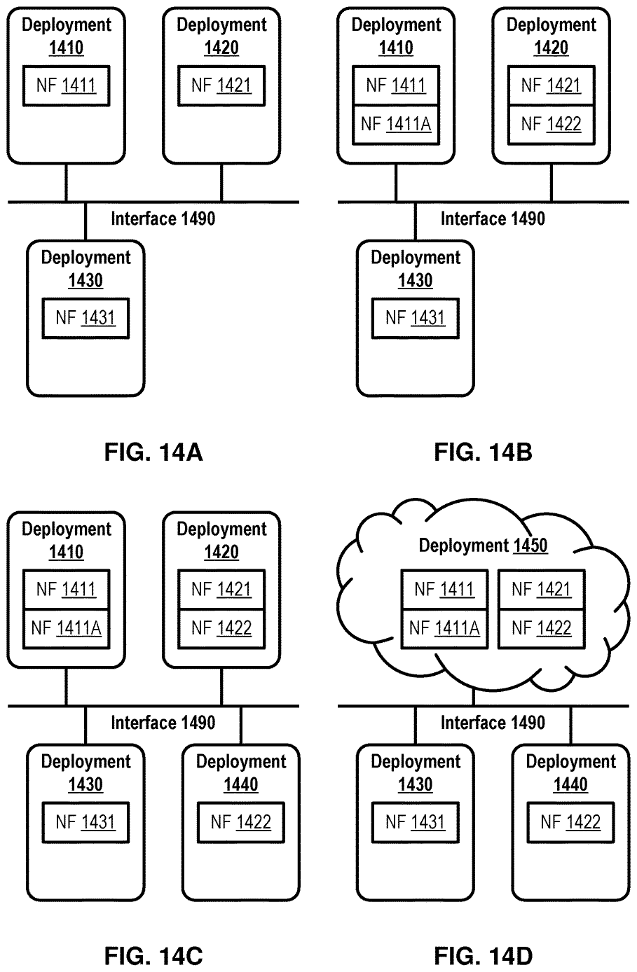

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

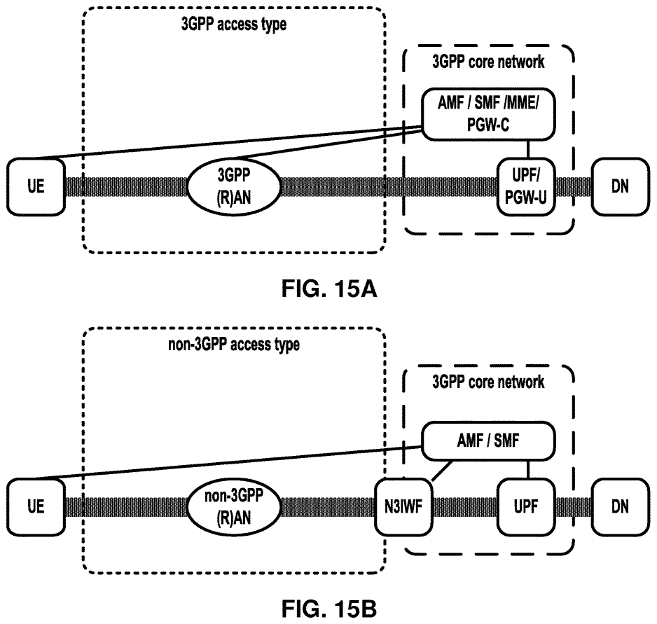

In an example embodiment as depicted in FIG. 15A and FIG. 15B, a UE may access a 3GPP system (network) via (using) one or more access types. For example, the one or more access types may comprise at least one of a 3GPP access type, a non-3GPP (N3GPP) access type, and/or a combination thereof.

For example, as shown in FIG. 15A, the UE may access a network via the 3GPP access type (e.g., 3GPP access). For example, the access to the network via the 3GPP access type may be an access to the network via one or more 3GPP RANs. For example, the one or more 3GPP RANs may comprise at least one of a global system for mobile communication (GSM) enhanced data-rates for global evolution (EDGE) radio access network (GERAN), a universal terrestrial radio access network (UTRAN), an evolved UTRAN (E-UTRAN), a next generation radio access network (NG-RAN), and/or a combination thereof. An operator of the network may trust a UE's access to the network via the 3GPP access type, because the one or more 3GPP RANs are managed and/or deployed by the operator.

For example, as shown in FIG. 15B, the UE may access the network via the N3GPP access (e.g., N3GPP access type). For example, the access to the network via the N3GPP access type may be an access to the network via one or more N3GPP RANs (or N3GPP AN). For example, the one or more N3GPP RANs may comprise at least one of a trusted WiFi, an untrusted WiFi, a wireline broadband, a WiMAX, and/or a combination thereof. The operator of the network may not trust the access to the network via the N3GPP access type, because the one or more N3GPP RANs may not be managed and/or deployed by the operator. For example, the WiFi equipment (e.g., router) may not be installed by the operator. To prevent unauthorized access of the UE via the one or more N3GPP RANs and/or to securely protect data/signaling, a non-3GPP interworking function (N3IWF) may be employed for the N3GPP access type. For example, the N3IWF may be employed for interworking between the one or more non-3GPP RANs and a 5G core network.

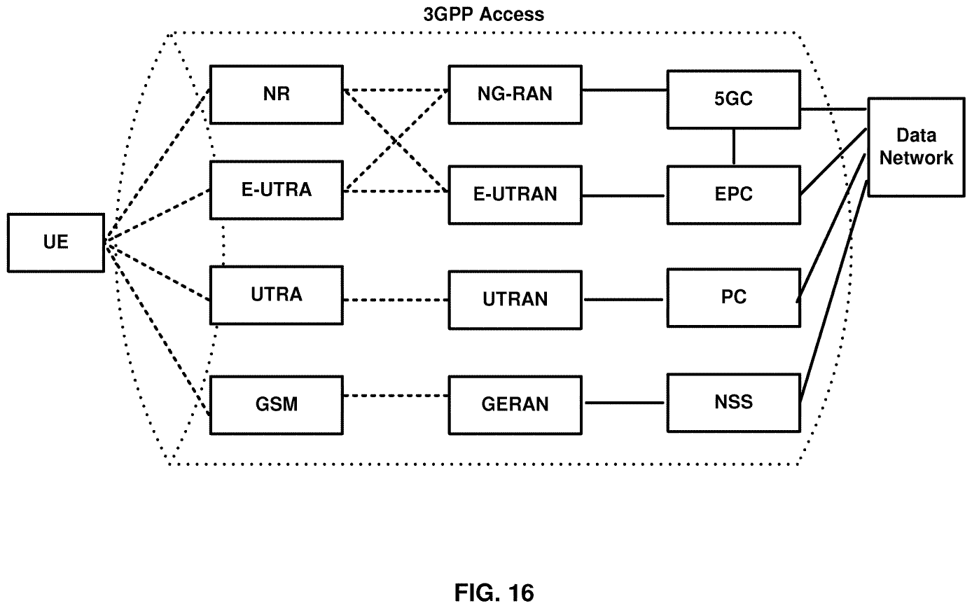

In an example embodiment as depicted in FIG. 16, the UE may exchange one or more data with a data network (DN), via the 3GPP access (type). The 3GPP access (type) may use one or more 3GPP RATs. The one or more 3GPP RATs may comprise at least one of NR, E-UTRA, UTRA, GSM, the like and/or a combination thereof. The 3GPP access may use one or more 3GPP RANs. The one or more 3GPP RANs may comprise at least one of the NG-RAN, the E-UTRAN, the UTRAN, the GERAN, the like and/or a combination thereof. The 3GPP RANs may use the one or more 3GPP RATs. The one or more 3GPP RANs may interface with a one or more core networks. The one or more core networks may comprise at least one of a 5G core (5GC), an evolved packet core (EPC), a packet core (PC), a network switching system (NSS), and/or a combination thereof.

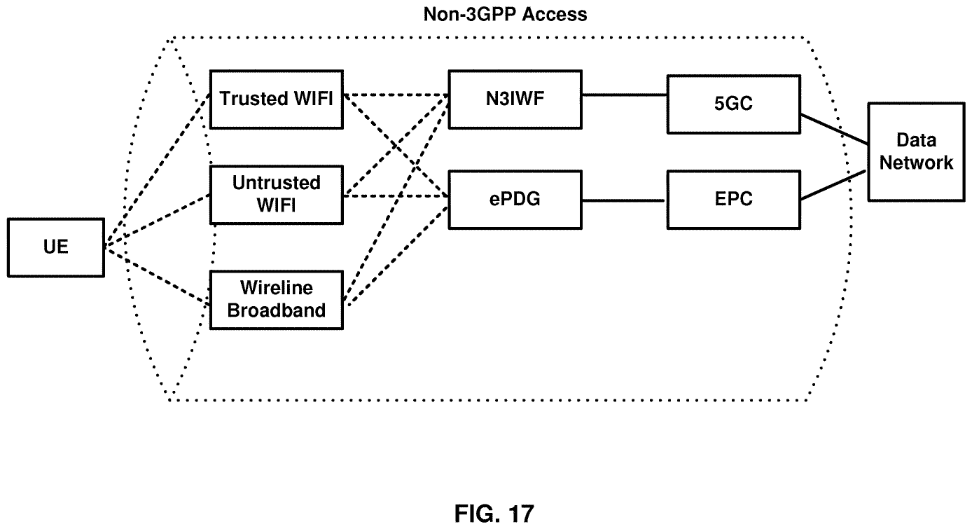

In an example embodiment as depicted in FIG. 17, the UE may exchange one or more data with the data network, via the N3GPP access (type). The N3GPP access may use one or more N3GPP RATs. The one or more N3GPP RATs may comprise at least one of the trusted WiFi, the untrusted WiFi, the wireline broadband, the like and/or a combination thereof. The N3GPP access may use one or more N3GPP access network (nodes). The one or more N3GPP access network nodes may comprise at least one of the N3IWF, an evolved packet data gateway (ePDG), a trusted non-3GPP gateway function (TNGF), a wireline access gateway function (W-AGF), the like and/or a combination thereof. The one or more N3GPP access nodes may interface with the one or more core networks (e.g., EPC and/or 5GC).

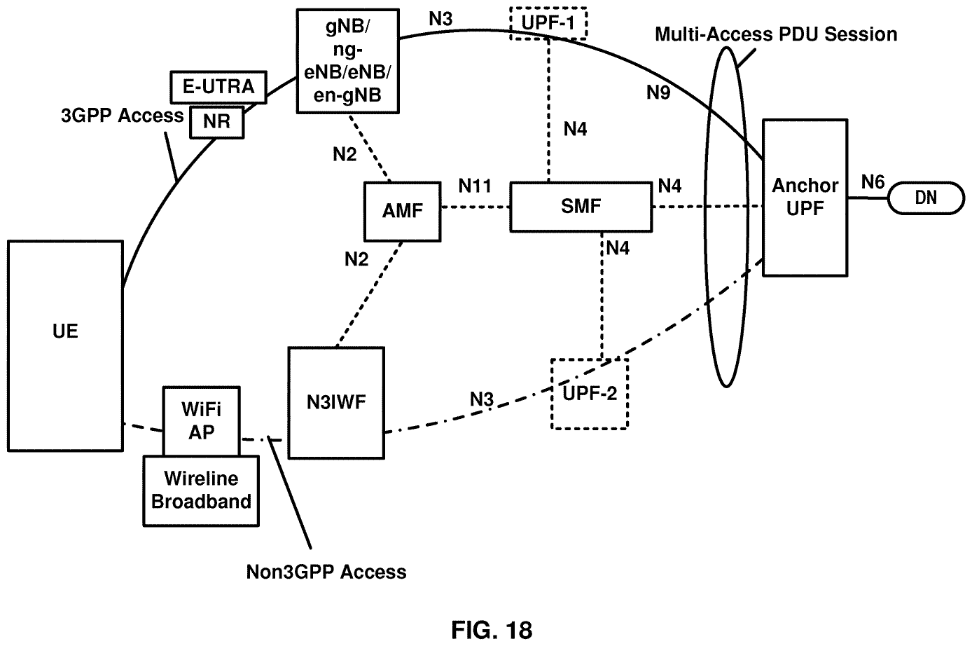

In an example embodiment as depicted in FIG. 18, the UE may establish a multi access PDU (MA PDU) session with the network. The MA-PDU session may be supported if the UE and the network support an access traffic steering switching splitting (ATSSS) feature (the feature of ATSSS). The ATSSS feature may enable a MA PDU connectivity service, which may exchange one or more PDUs between the UE and the data network by a first tunnel (e.g., a N3/N9 tunnels between a UPF (e.g., an anchor UPF, a packet switching anchor) and the 3GPP RAN) of one 3GPP access and a second tunnel (e.g., a N3/N9 tunnels between the UPF and the N3GPP RAN) of one non-3GPP access. The MA PDU connectivity service may be realized by establishing the Multi Access PDU (MA PDU, MA-PDU) Session. The MA PDU session may be a PDU Session that may have user-plane resources on the 3GPP access and the N3GPP access. For example, the resources on the 3GPP access may comprise resources provided by the 3GPP RATs (e.g., E-UTRA, NR), the 3GPP RAN nodes (e.g., gNB, ng-eNB, eNB, en-gNB, the like, and/or a combination thereof), a first UPF (UPF-1, if configured between the anchor UPF the 3GPP RAN), the anchor UPF, and/or the like. For example, the resources on the N3GPP access may comprise resources provided by the N3GPP RATs (e.g., WiFi, WiMAX, wireline broadband, and/or the like), the N3GPP RAN nodes (e.g., ePDG, N3IWF, TNGF, W-GAN, the like, and/or a combination thereof), a second UPF (UPF-2, if configured between the anchor UPF the N3GPP RAN), the anchor UPF and/or the like. For the MA PDU session, the data network or applications of the UE may use the same identity (e.g., IP address). For example, source IP address (and/or destination IP address) of the packets (e.g., PDUs) of the MA PDU session sent over the 3GPP access may be same as the source IP address (and/or destination IP address) of the packets of the MA PDU sent over the N3GPP access.

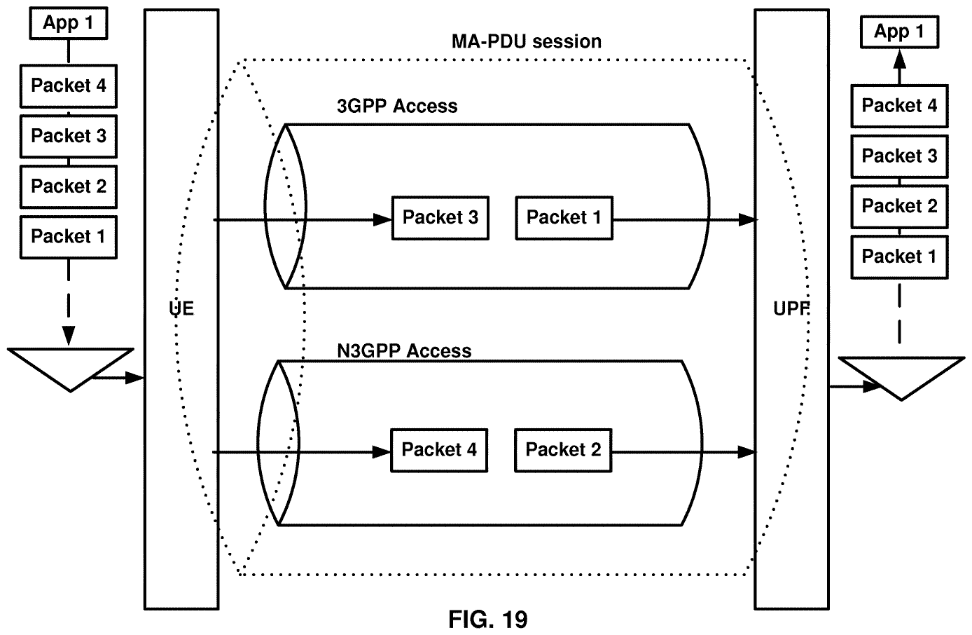

In an example, using two resources (e.g., one from 3GPP access, the other from N3GPP access) for the MA PDU session may provide enhanced reliability, efficient use of network resources, and/or adaptation to changing environment. For example, as depicted in FIG. 19, the UE and the UPF (e.g., anchor UPF) may establish the MA PDU session. The MA PDU session may comprise the 3GPP access and the N3GPP access. For example, the 3GPP access may use the resources as shown in FIG. 18 (or FIG. 16) and/or the N3GPP access may use the resources as shown in FIG. 18 (or FIG. 17). Reverting back to FIG. 19, the 3GPP access and the N3GPP access may provide different characteristics of data transfer. For example, the 3GPP access may provide a wider coverage than the N3GPP access. For example, the N3GPP access may provide higher throughput than the N3GPP access. By utilizing these different characteristics of the two accesses, the operator of the network may determine how to transport packets over the two accesses of the MA PDU session. For example, if both accesses provide similar performance, the operator may determine to distribute loads equally on these accesses. For example, a half (e.g., packet 1 and packet 3) of the PDUs may be transferred over the 3GPP access while the remaining half of the PDUs (e.g., packet 2 and packet 4) may be transferred over the N3GPP access. In other example (not shown in the figure), if transfer delay (e.g., 30 ms) over the 3GPP access is three times larger than the transfer delay (e.g., 10 ms) over the N3GPP access, the operator may determine to send three times more PDUs (e.g., packet 6, packet 7, packet 8) over the N3GPP access than the PDUs (e.g., packet 5) sent over the 3GPP access. In existing technologies, for the MA PDU session, a core network node (e.g., AMF, SMF, UPF) may be able to distinguish one access type (e.g., 3GPP access type) from the other access type (e.g., N3GPP access type), because different network nodes (e.g., gNB, N3IWF) are used for each access.

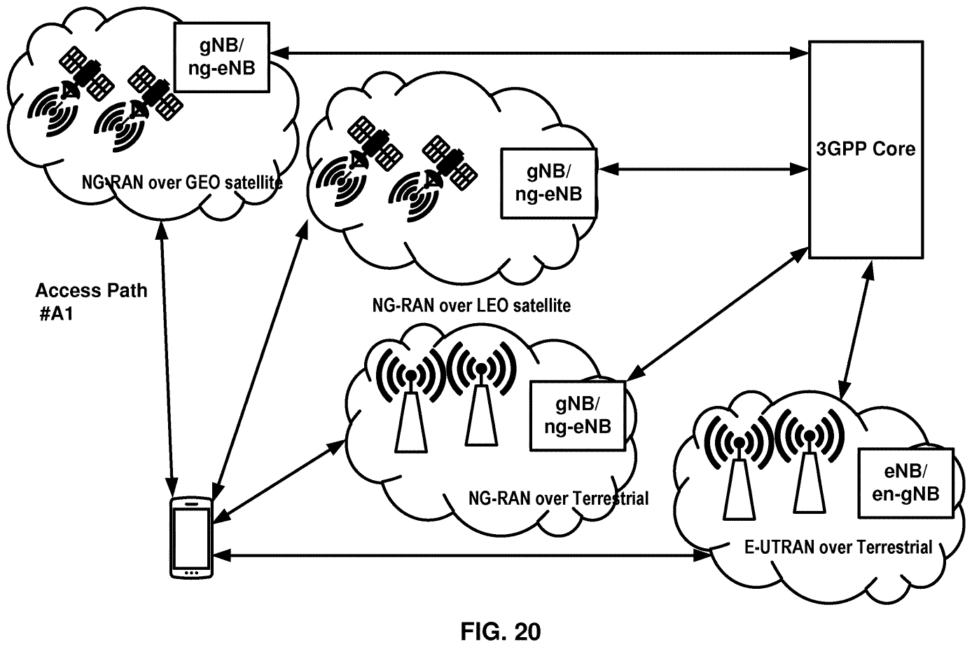

As 5G system (5GS) advances, 3GPP accesses may also advance. As shown in the FIG. 20, one or more 3GPP RANs may be diversified and/or may be deployed in differentiated areas. In existing technologies, an access node and/or a radio access network may be deployed as a terrestrial node (on the ground) or with similar frequencies (e.g., 2 Ghz). In other words, the access node may be deployed on the ground, in the building and/or the like, and due to limitation of supported frequencies, may use similar frequency bands. As a result, there may not be much gain in differentiating a (e.g., first type) 3GPP RAN from other (e.g., second type) 3GPP RANs. As 5G system equipment becomes smaller and signal of UEs with limited power become capable of reaching satellites, deploying the 3GPP access nodes (RANs) onto the satellites may become feasible. For example, a first NG-RAN of the one or more 3GPP RANs may be deployed over a geostationary equatorial orbit (GEO). For example, a second NG-RAN of the one or more 3GPP RANs may be deployed over a low earth orbit (LEO). For example, a third NG-RAN of the one or more 3GPP RANs may be deployed as a terrestrial (e.g., on the ground, in the building) access network. For example, a fourth E-UTRAN of the one or more 3GPP RANs may be deployed as a terrestrial access network. These different 3GPP RANs may provide different characteristics. For example, the first NG-RAN may provide a coverage in a remote area where terrestrial 3GPP RANs cannot be deployed. For example, the second NG-RAN may provide a wider coverage than the terrestrial NG-RAN, with a reduced throughput. For example, the one or more 3GPP RAN may be connected to one or more 3GPP core networks. For example, the one or more 3GPP core networks may belong to one or more networks. For example, the first NG-RAN and/or the second NG-RAN may be connected to a first core network. For example, the third NG-RAN may be connected to a second core network. For example, the first core network may belong to a first network. For example, the third NG-RAN may be connected to a second core network. For example, the first core network may belong to a first network and/or a first operator. For example, the second core network may belong to a second network and/or a second operator. In these diversified scenarios, it may be beneficial to use multiple 3GPP RANs for the UE and/or for the MA PDU session, instead of using one 3GPP access and one N3GPP access. However, this may bring a problem when there is a change in the one or more 3GPP access, as explained below.

In an example of existing technologies, one or more 3GPP access paths for a UE and/or a PDU session can change at any time. For example, a new 3GPP access path can be added, an existing 3GPP access path can be removed, or a type of the 3GPP access path can change. If a configuration of the UE, the PDU session, and/or one or more network nodes is not properly updated, QoS requirement of a data communication may not be supported and/or network resources for the data communication may unnecessarily wasted.

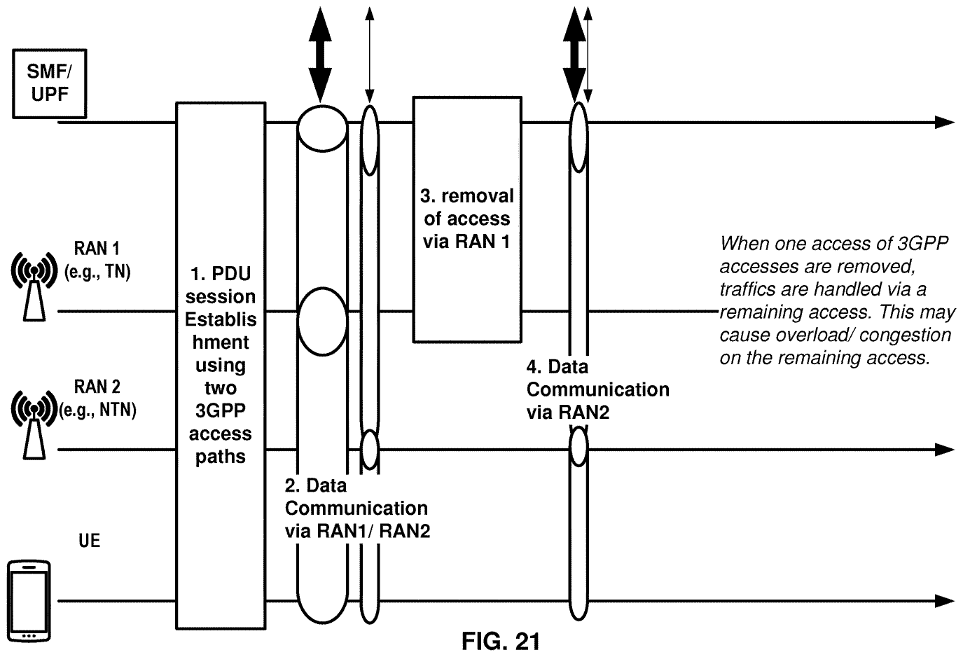

In an example of existing technologies, as depicted in FIG. 21, a UE may register via one or more 3GPP access paths, and may establish a PDU session using the one or more 3GPP access paths.

In an example, the UE may send a first request message (e.g., a first registration request message) to a core network node (e.g., an AMF, an MME, core network node of first network (e.g., NPN 1, PLMN 1) and/or the like) via a RAN 1 (e.g., an TN RAN) of 3GPP access type. For example, a first path via the RAN 1 may be a first access path (e.g., first 3GPP access path) of the 3GPP access, or a first 3GPP access. For example, the RAN 1 may use a wire connection to a UPF and may support a high bitrate (e.g., 10 Gbps) or a low error rate (e.g., less than 10 ms). In response to receiving the first request message, the core network node may send to the UE, a first response message (e.g., a first registration accept message). For example, the first response message may indicate that the UE is registered via the first 3GPP access.

In an example, the UE may receive the first response message. Because the UE supports a feature of multiple steering (e.g., dual steering, dualsteer), after receiving the first response message, the UE may determine to perform additional registration for an additional access path of the 3GPP access. For example, the UE may search one or more available networks and/or one or more available 3GPP access paths. For example, the UE may find a second RAN (RAN 2). The RAN 2 may be a non-terrestrial (e.g., satellite, airborne) network, a non-terrestrial RAN of the 3GPP access type. For example, a second path via the RAN 2 may be a second access path (e.g., a second 3GPP access path) of the 3GPP access, or a second 3GPP access. For example, a UE may have one or more AS protocol stacks (e.g., one or more modem). For example, the UE may have a first AS stack (e.g., a first RRC, a first PDCP, a first RLC, a first MAC, a first PHY) and/or a second AS stack (e.g., a second RRC, a second PDCP, a second RLC, a second MAC, a second PHY), and/or the like. The UE may use the first AS stack for the first access path and/or the UE may use the second AS stack for the second access path. For example, the configuration for the first AS stack may change (e.g., from using a cell A (e.g., Frequency A, TA A, E-UTRA, NTN) to using cell B (e.g., Frequency B, TA B, NR, TN) while configuration for the second AS stack does not change.

In an example, the UE may select the RAN 2 for the second access path for the 3GPP access type. The UE may send a second request message (e.g., a second registration request) to a core network node 2 (e.g., core network node 2, AMF 2, MME 2, core network node of second network (e.g., NPN 2, PLMN 2)) via the RAN 2. The core network node 2 may be the core network node.

In an example, the core network node 2 may receive the second request message and may send a second response message (e.g., a second registration accept message) to the UE. For example, the second response message may indicate successful registration of the second access path. For example, the UE may be registered simultaneously (concurrently) via the first access path of 3GPP access type and the second access path of the 3GPP access type. For example, the UE may communicate one or more data packets via the first access path and/or the second access path.

In an example, after registering the first access path and the second access path, the UE may determine to establish a PDU session using the first access path and the second access path. For example, to establish the PDU session, the UE may send a third request message to a SMF. For example, the third request message may be a PDU session establishment/modification request message. Based on that the PDU session is using the first access path and/or the second access path, the SMF may determine a QoS configuration for the PDU session. For example, based on supported capacity of the first access path (e.g., 500 Mbps) and/or the second access path (e.g., 10 Mbps), the SMF may determine the QoS configuration (e.g., 510 Mbps). Based on the QoS configuration, the SMF may send a third response message and/or may configure one or more NG-RANs and/or a UPF.

In an example, the UE may send and receive data over the PDU session. Because the first access path and the second access path are available, a first provided QoS to the UE may be high (e.g., 500 Mbps). For example, one or more applications of the UE may keep generating high volume of data and/or may communicate the high volume of data via using the PDU session.

In an example, the UE may move to an area where the first access path is not available. For example, the area may be a tunnel or a remote area where terrestrial equipment may not be deployable. Because the first access path is not available, the UE may use the second access path for the PDU session and/or the UE may not use the first access path for the PDU session. Because, the PDU session is supported via the second access path, a second provided QoS to the UE may be low (e.g., 10 Mbps), compared to the first provided QoS (which uses both the first access path and the second access path).

In this case, the high volume of data flowing over the first access path may be diverted to use the second access path. Due to limited capacity of the second access path, most of the high volume of data may not be delivered over the second access path, may be discard locally in the UE, may delay transmission of important data, and/or may cause congestion of radio resource of the second access path.

In examples of this disclosure, a signalling may be enhanced to modify configured QoS based on change of one or more 3GPP access paths. For example, a core network node may indicate support of dualsteer, may indicate request for dualsteer to a policy control node. This may assist the policy control node to determine whether to provide policy control information and/or may prevent unnecessary provision of the policy control information. In another example, the policy control node may send one or more triggering condition information to the core network node to control when the core network node to request updated policy control information for dualsteer. This may assist the policy control node to adjust one or more QoS parameter for using a feature of dualsteer. In another example, the core network node may report one or more events of the one or more access paths to the policy control node, based on the one or more triggering condition. This may help the policy control node to make a timely decision. In another example, a first mobility node may send, to a second mobility node, information of the policy control node and/or information of the one or more triggering condition. This may initiate a configuration update when one or more management nodes for the UE changes during handover.

In the specification, the term “5G access network” may be interpreted as, or may refer to, an access network comprising at least one of a NG-RAN and/or non-3GPP AN, and connecting to a 5G core network.

In the specification, the term “5G core network” may be interpreted as, or may refer to, a core network connecting to a 5G access network. This may be 5G core (5GC).

In the specification, the term “3GPP RAN” may be interpreted as, or may refer to, a radio access network using 3GPP RAT. For example, this may comprise at least one of a gNB, an eNB, a ng-eNB, an en-gNB, the like, and/or a combination thereof. For example, this may be at least one of an E-UTRAN, NG-RAN, the like, and/or a combination thereof.

In the specification, the term “3GPP RAT” may be interpreted as, or may refer to, a radio access technology based on 3^{rd} generation partnership (3GPP) project. For example, this may comprise at least one of a NR, a E-UTRA, UTRA, GSM, the like, and/or a combination thereof.

In the specification, the term “N3GPP RAN” may be interpreted as, or may refer to, an access network using non-3GPP (N3GPP) RAT. This may be N3GPP access network (AN). For example, this may comprise at least one of N3IWF, ePDG, TNGF, W-GAN, the like, and/or a combination thereof.

In the specification, the term “network node” may be interpreted as, or may refer to, at least one of a core network node, an access node, a UE, the like, and/or a combination thereof. A network may comprise one or more network nodes.

In the specification, the term “3GPP access node” may be interpreted as, or may refer to, an access node using a 3GPP RAT. For example, this may comprise at least one a gNB, an eNB, a ng-eNB, an en-gNB, the like, and/or a combination thereof.

In the specification, the term “N3GPP access node” may be interpreted as, or may refer to, an access node using a N3GPP RAT. For example, this may comprise at least one of N3IWF, ePDG, TNGF, W-GAN, the like, and/or a combination thereof.

In the specification, the term “N3GPP RAT” may be interpreted as, or may refer to, a radio access technology not based on 3^{rd} generation partnership project. This may be an access technology not developed by 3GPP. For example, this may comprise a WiFi, trusted WiFi, non-trusted WiFi, fixed access, wireline broadband, the like, and/or a combination thereof.

In the specification, the term “access type” may be interpreted as, or may refer to, indicating a type of access used for communicating with a network. For example, this may comprise a 3GPP access type (or 3GPP access) and/or a N3GPP access type (or N3GPP access). For example, if the access type is the 3GPP access type, this may indicate that a UE is communicating with the network by using one or more 3GPP RATs, and/or via one or more 3GPP RANs. For example, if the access type is the N3GPP access type, this may indicate that a UE is communicating with the network by using one or more N3GPP RATs, and/or via one or more N3GPP RANs. In an example, access may comprise at least one of sending a data, receiving a data, sending a signalling message, receiving a signalling message, performing registration, and/or the like.

In the specification, the term “3GPP access type” may be interpreted as, or may refer to, an access using one or more 3GPP RATs, and/or via one or more 3GPP RANs.

In the specification, the term “N3GPP access type” may be interpreted as, or may refer to, an access using one or more N3GPP RATs, and/or via one or more N3GPP RANs.

In the specification, the term “MA PDU Session” may be interpreted as, or may refer to, a PDU Session that provides a PDU connectivity service, which can use/establish one access type at a time, or simultaneously one 3GPP access and one N3GPP access, simultaneously more than one paths of 3GPP access type or simultaneously more than one paths of N3GPP access type.

In the specification, the term “NG-RAN” may be interpreted as, or may refer to, a base station, which may comprise at least one of a gNB, a ng-eNB, a relay node, a base station central unit (e.g., gNB-CU), a base station distributed unit (e.g., gNB-DU), and/or the like. This may be a radio access network that connects to 5GC, supporting at least one of NR, E-UTRA, and/or a combination thereof.

In the specification, the term “E-UTRAN” may be interpreted as, or may refer to, a base station, which may comprise at least one of an eNB, an en-gNB, and/or the like. This may be a radio access network that connects to evolved packet core (EPC), supporting at least one of NR, E-UTRA, and/or a combination thereof.

In the specification, the term “RAT type” may be interpreted as, or may refer to, identifying the transmission technology used in the access network for 3GPP accesses and/or for non-3GPP accesses. For example, RAT type for 3GPP access may comprise at least one of NR, NB-IOT, E-UTRA, and/or the like. For example, RAT type for non-3GPP access may comprise at least one of untrusted non-3GPP, trusted non-3GPP, trusted IEEE 802.11 non-3GPP access, Wireline, Wireline-Cable, Wireline-BBF, WiFi, etc.

In the specification, the term “core network node” may be interpreted as, or may refer to, a core network device, which may comprise at least one of an AMF, a SMF, a NSSF, a UPF, a NRF a UDM, a PCF, a SoR-AF, an AF, an DDNMF, an MB-SMF, an MB-UPF, a MME, a SGW, a PGW, a SMF+PGW-C, a SMF+PGW-U, a UDM+HSS and/or the like.

In the specification, the term “network system” may be interpreted as, or may refer to, a communication system, and/or a generation of the communication system. For example, one or more network systems may comprise an EPS, a 5GS. For example, the first network system may be the EPS. The EPS may comprise of one or more UEs, one or more eNB, one or more en-gNBs, one or more EPCs. The one or more EPCs may comprise a MME, a SGW, a PGW, and/or the like. For example, the second network system may be the 5GS. The 5GS may comprise of one or more UEs, one or more gNB, one or more ng-eNBs, one or more 5G core networks. The one or more 5G core networks may comprise an AMF, a SMF, a PCF, and/or the like.

In the specification, the term “5G System” may be interpreted as, or may refer to, a 3GPP system consisting of at least one of 5G access network (or NG-RAN), 5G core network and/or a UE.

In the specification, the term “EPS” may be interpreted as, or may refer to, a 3GPP system consisting of at least one of EPC, E-UTRAN and/or a UE.

In the specification, the term “access path” may be interpreted as, or may refer to, a path between a UE and a network for exchange of data and/or signalling. The access path may be an access leg, a path, an access route (route), an access track (track), an access channel (channel), an access corridor (corridor), an access link (link) and/or the like. The access path may indicate (be associated with) at least one of a path from a UE to a RAN, a path from a UE to a core network, a path from a RAN to a core network, the like, and/or a combination thereof. For example, the access path may be defined per a pair of a core network and/or an access network. For example, a path for a data between an access node and a core network may not be an access path if the access node and the core network may not be able to exchange a control signalling. For example, if a secondary node of a NG-RAN cannot exchange signalling messages with an AMF, the path between the secondary node of the NG-RAN to a core network (e.g., a UPF) may not be an access path. In an example, one or more access paths may be defined for an access type. The one or more access paths may be established for the access type. In another example, an access path may be associated with one or more core networks (e.g., roaming networks, visiting network, home network, anchor networks) and/or an access network. In one example, one or more 3GPP access paths may be one or more 3GPP accesses. For example, for 3GPP access type, one or more 3GPP access (e.g., access paths) may be configured.

For example, for each access type, there may be one or more access paths. For example, the one or more access paths may be used to transport signalling message for the access type. For example, there may be one or more (established, active) access paths (of signalling, of control message delivery) between the UE and the core network (e.g., AMF, SMF, PCF). For an access path, there may be an associated control plane connection. For example, for a UE, an AMF may be able to exchange a control message with a first gNB and/or a UPF may exchange data with the first gNB and/or the second gNB. In this case, the UE may be considered as having one path. For example, the link via the first gNB may be an access path, because the first gNB may be able to exchange control plane signalling with the AMF (and/or an SMF). For example, the link via the second gNB may not be considered as a path, because the AMF and the second gNB may not be able to exchange control plane signalling.

For example, the access path may comprise at least a control plane. For example, the access path may or may not have a user plane. Before establishing a bearer transporting user data (e.g., voice data, IP packets), the access path may not have the user plane. After establishing the bearer, the access path may have the user plane.

For example, using the example of FIG. 20, one or more access paths may comprise:
a path (e.g., access path A, 3GPP access A, an access A of a 3GPP access type) from the UE via the NG-RAN over GEO satellite and to a 3GPP core.
a path (e.g., access path B, 3GPP access B, an access B of a 3GPP access type) from the UE via the NG-RAN over LEO satellite and to a 3GPP core.
a path (e.g., access path C, 3GPP access C, an access C of a 3GPP access type) from the UE via the NG-RAN over Terrestrial (gNB) and to a 3GPP core.
a path (e.g., access path D, 3GPP access D, an access D of a 3GPP access type) from the UE via the NG-RAN over Terrestrial (eNB) and to a 3GPP core.
a path (e.g., access path E, 3GPP access E, an access E of a 3GPP access type) from the UE via the NG-RAN via a first 3GPP core (e.g., a first AMF) to a second 3GPP core (e.g., a second AMF).

For example, a UE may have one or more 3GPP access paths. The one or more 3GPP access paths may be defined/established/associated for 3GPP access type. Each 3GPP access path of the one or more 3GPP access path may support delivery of a control message (e.g., registration request message, PDU session establishment request message, and/or the like) and/or a control message (e.g., Initial UE message, N2 message, and/or the like) for a 3GPP access node. For example, the one or more 3GPP access path may comprise at least one of:
one or more first-type 3GPP access paths: A first-type 3GPP access path may be a route associated a UE, a NG-RAN, a core network.
one or more second-type 3GPP access paths: A second-type 3GPP access path may be a route associated with a UE, a E-UTRAN, and/or a core network.

For example, a UE may have one or more N3GPP access paths. The one or more N3GPP access paths may be defined/established/associated for N3GPP access type. Each N3GPP access path of the one or more N3GPP access path may support delivery of a control message (e.g., registration request message, PDU session establishment request message, and/or the like) and/or a control message (e.g., Initial UE message, N2 message, and/or the like) for a N3GPP access node. For example, the one or more N3GPP access path may comprise at least one of:
one or more first-type N3GPP access paths: A first-type N3GPP access path may be a route associated a UE, a N3IWF, a core network.
one or more second-type N3GPP access paths: A second-type N3GPP access path may be a route associated a UE, an ePDG, a core network.
one or more third-type N3GPP access paths: A third-type N3GPP access path may be a route associated with a UE, an TNGF (trusted non-3GPP gateway function), and/or a core network.
one or more fourth-type N3GPP access paths: A fourth-type N3GPP access path may be a route associated a UE, a W-AGF (wireline access gateway function), a core network.

In the specification, the term “support of dualsteer” may be interpreted as, or may refer to, support of a feature of dualsteer. The feature of dualsteer may comprise at least one of performing more than one registrations over an access type, performing additional registrations for the access type while registered for the access type, adding additional access path for the access type, using (simultaneously, concurrently) multiple access paths for the access type, being registered (simultaneously, concurrently) for multiple access paths for the access type, and/or the like. Supporting the feature of dualsteer by a node may be that the node is able to handle, process, interpret, sending, receiving, acting based on, and/or the like, an information associated with dualsteer. For example, the information associated with dualsteer may be a subscription data, a cause value, a network slice information associated with the dualsteer, a policy information associated with the dualsteer, a configuration information associated with the dualsteer, and/or the like. For example, dualsteer may be called as dualsteering, multiple steering, multiple access paths registration, multiple access paths managements, multiple 3GPP accesses, multiple access connections, and/or the like.

In the specification, the term “dualsteer policy” may be interpreted as, or may refer to, a policy information associated with a feature of dualsteer. For example, the dualsteer policy may be one or more information of a policy. For example, the policy may be at least one of a policy and charging control (PCC) rule, AM (access and mobility) policy, SM (session management) policy, a UE policy, and/or the like. For example, the AM policy may be access and mobility related policy information. For example, the dualsteer policy may comprise at least one of the policy information may indicate one or more parameters for the feature of dualsteer, one or more conditions for using the one or more parameters. For example, the dualsteer policy may indicate one or more QoS parameter for dualsteer, one or more QoS characteristics for dualsteer, one or more QoS rule for dualsteer, one or more charging rule for dualsteer, and/or one or more monitoring rule for dualsteer. For example, dualsteer policy may be one or more policy information for the case when a UE (or a PDU) is configured/allowed to use more than one 3GPP access paths (including the case where the UE is using a 3GPP access path and is preparing/intending to add addition 3GPP access path).

In the specification, the term “policy trigger” may be interpreted as, or may refer to, one or more events initiating a report. For example, the initiating the report may comprise at least one of detecting the one or more events by a first node, and/or sending the report indicating the one or more events by the first node to a second node. For example, the first node may send the report, when the first node determines that one or more events indicated by the policy trigger occurs. For example, the first node may trigger a policy update request procedure, if the event of the policy trigger occurs. The second node may indicate to the first node, information of the policy trigger. The policy trigger may be a policy control request trigger (PCRT). For example, the policy control request trigger may indicate one or more conditions. For example, the one or more conditions may be a criterion to determine whether a event occurs or not, and/or whether a policy control request needs to be triggered (e.g., sent) to the second node. For a case of sending configuration from a PCF to a SMF/AMF, policy trigger may mean one or more criterion, one or more condition, and/or one or more events. For a case of sending report from a PCF to a SMF/AMF, policy trigger may mean one or more event that occurs, one or more condition (criterion) that is met. For example, a condition may indicate one or more events. For example, the SMF/AMF may report if at least one event of the condition is met (occurs).

In the specification, the term “mobility management node” may be interpreted as, or may refer to, a function and/or a node performing mobility management for a UE. For example, mobility management may be at least one of management of registration status, management of context, management of authorization, management of registration area, management of paging, and/or the like. For example, the mobility management node may comprise at least one of a MME, AMF, and/or the like.

In an example, the UE may use one or more subscriptions. For example, the UE may use a first subscription for a first access path and/or the UE may use a second subscription for a second access path. While this may prevent the first access path from removing registration of a second access path, when the UE performs registration to the second access path, the data exchange in the first access path may not be harmonized with the data exchanges in the second access path. For example, a first IP address supported by the first subscription may be different from a second IP address supported by the second subscription. This may not properly support MA-PDU session, if the QoS allowed for the first subscription is different from the QoS allowed for the second subscription. For example, in case of dualsteer, the UE may use a subscription for a plurality of 3GPP access paths simultaneously. For example, the UE may use the subscription for a first 3GPP access path (e.g., TN, network 1) while using the subscription for a second 3GPP access path (e.g., NTN, network 2)

In an example, a PDU session may be established to support a plurality of 3GPP accesses (3GPP access paths). In some scenarios, the PDU session may additionally use a resource of N3GPP access. Though some figures may be depicted without the N3GPP access, it may be understood that the description is also applicable to a case where the PDU session is allowed to use the plurality of 3GPP accesses and the N3GPP access.

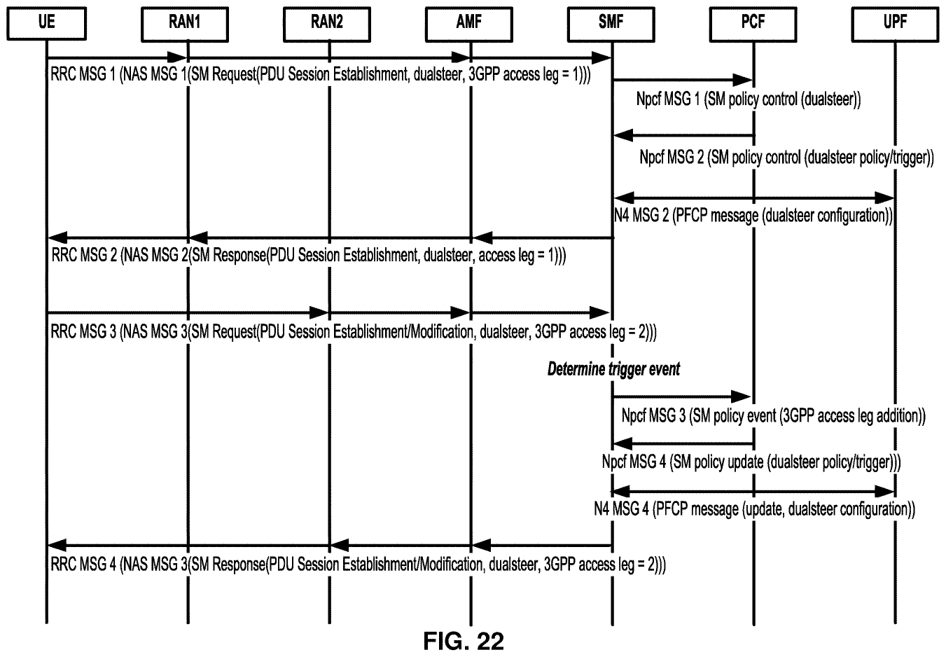

FIG. 22 depicts one example embodiment of the present disclosure. In an example, a SMF may receive an information of one or more policy triggers for dualsteer from a PCF. This may help the SMF to determine when to request a policy update for a PDU session configured to use one or more 3GPP access paths. For brevity, based on the other part of the present disclosure, redundant details will be omitted.

In an example, the UE may perform a first registration via a first RAN (e.g., RAN 1) and/or a second registration via a second RAN (e.g., RAN 2). In other example (not shown in the figure), the UE may perform the second registration after establishing a PDU session via the first RAN.

In an example, after the UE is registered via the first RAN and/or the second RAN, the UE may determine to establish the PDU session, to serve a data communication service. For example, the UE may determine to establish the PDU session by using one or more 3GPP access paths. For example, the UE may send a RRC message 1 (RRC MSG 1) to the first RAN (e.g., a RAN 1, a first gNB, and/or the like) to establish the PDU session. The RRC message 1 may be at least one of a first RRC setup complete message, a first RRC UL transport message, and/or the like. The RRC message 1 may comprise a NAS message 1 (NAS MSG 1). The NAS MSG 1 may be at least one of a first PDU Session Establish request message, a first PDU Session Modification request message, a first UL NAS transport message, and/or the like. The NAS MSG 1 may comprise at least one of a first SM message (e.g., a first PDU session associated message (e.g., a first PDU Session establishment request message, a first PDU session modification request message), a first SM container), an identifier of the UE, an identifier (e.g., PDU session ID) of the PDU session, a first requested QoS parameter, a request for a MA PDU session, a request for dualsteer session (e.g., the PDU session supports more than one 3GPP access path), a one or more capabilities of the UE, an identifier (S-NSSAI) of a network slice for the PDU session, a DNN for the PDU session, an indication of dualsteer, an indication (e.g., that the first access path is used for the request, an identifier, and/or the like) of the first access path, and/or the like. The one or more capabilities of the UE may comprise a dualsteer capability indicator. For example, the dualsteer capability indicator may indicate that the UE supports a feature of dualsteer, that the UE supports a PDU session using one or more 3GPP access paths. The dualsteer capability indicator may assist the network to determine whether to apply enhanced handling to support multiple access paths (e.g., 3GPP accesses) of an access type (3GPP access) for the UE (or for the PDU session).

In an example, the RAN 1 may receive the RRC MSG 1. In response to receiving the RRC MSG 1, the RAN 1 may send a first NG MSG (NG MSG 1) to an AMF 1. For example, the NG MSG 1 may comprise the NAS MSG 1 and/or a first UE location information. For example, the NG MSG 1 may be initial UE message. For example, the first UE location information may indicate a first cell ID of a first cell from which the UE access a network, a first identifier of a first TA of the first cell from which the UE access the network. For example, the first cell ID and/or the first identifier of the first TA may be associated with the first access path of the 3GPP access type.

In an example, the AMF 1 may receive from the RAN 1, the NG MSG 1. In response to receiving the NAS MSG 1 of the NG MSG 1, the AMF 1 may send a first Nsmf message to a SMF. For example, the first Nsmf message may comprise the NAS MSG 1 and/or one or more information element of the NAS MSG 1. For example, the first Nsmf message may be at least one of first Nsmf_PDUSession_Create request, first Nsmf_PDUSession_Update request, first Nsmf_PDUSession_CreateSMContext request, first Nsmf_PDUSession_UpdateSMContext request and/or the like. For example, the first Nsmf message may comprise at least one of PEI, the S-NSSAI, the PDU Session ID, the first N1 SM container, the first UE location information (e.g., the location of the UE via the first access path, e.g., first cell Id of the first access path, RAN 1 ID of the first access path, first TA of the first access path), indication of request of MA PDU session, indication of request of dualsteer (for the PDU session), information of one or more 3GPP access paths registered by the UE, indication of whether the UE supports the feature of dualsteer, indication of whether the AMF 1 supports the feature of dualsteer, a first RAT type of the first access path. For example, the first N1 SM container may be the NAS MSG 1 and/or the one or more information element of the NAS MSG 1. The first UE location information may help the SMF to determine one or more first parameters used for the first access path. For example, the AMF 1 may receive the first UE location information from the RAN 1 via the NG MSG 1. For example, the indication of the first access path may indicate at least one of that the first N1 SM container is received via the first access path, that the first Nsmf message is associated with the first access path, that the first access path (the first 3GPP access) is requested to be used for the PDU session, and/or the like.

In an example, the SMF may receive the first Nsmf message. Based on the information in the first Nsmf message, the SMF may determine to establish a SM policy session (association) with a PCF. For example, because the first Nsmf message comprises an indication that the UE requests establishment of a PDU session using one or more 3GPP access path (e.g., dualsteer), the SMF may determine to get a SM policy from the PCF.

In an example, the SMF may send to the PCF, a first Npcf message (Npcf MSG 1). For example, the Npcf MSG 1 may be at least one of first Npcf_Policy_Authentication Create Request message, first Npcf_SMPolicyControl Request message, first Npcf_SMPolicyControl_Update Request message, first Npcf_SMPolicyControl_UpdateNotify Request message, and/or the like. For example, the first Npcf message may comprise at least one of the identifier of the UE (e.g., SUPI), the PDU session ID, the DNN, the S-NSSAI, the first RAT type of the first access path, the access type of the first access path, indication of support of the feature of dual steer by the UE, indication of request of dualsteer, indication of request of using a plurality of 3GPP access paths, indication of support of the feature of dualsteer by the AMF 1, indication of subscription of the UE for the use of the feature of the dualsteer, indication that the dualsteer PDU session (e.g., using a plurality of 3GPP access) is requested, requested QoS information of the PDU session, information (e.g., whether TN or NTN, whether PLMN or SNPN, backhaul type, capacity, frequency) of one or more 3GPP access paths requested for the PDU session, information of one or more 3GPP access paths registered (used) for the UE, the first UE location information and/or the like. For example, Npcf MSG 1 may comprise a feature tag. For example, the feature tag may indicate that the SMF can support at least one of handing a policy control request trigger for the feature of dualsteer (e.g., receive/send/process/determine a policy for a plurality of 3GPP access path)

In an example, the PCF may receive the first Npcf message. Because the first Npcf message indicates information associated with the dualsteer, the PCF may determine to construct a first SM policy information for the PDU session (e.g., PDU session related policy information) and/or a first police control request trigger. The first SM policy information may comprise one or more information associated with the dualsteer. For example, the first SM policy information may comprise at least one of a first charging information, a first policy control request trigger, a first QoS characteristic, a first authorized 5QI, a first PCC rules, and/or the like.

For example, the first policy control request trigger may define one or more events that cause re-request of policy information (e.g., PCC rules) for the PDU session. For example, the first policy control request trigger may comprise at least one of a PLMN change, a QoS change, a change in access type, a change for dualsteer, and/or the like. For example, the change for dualsteer may comprise at least one of an addition of an access path to the PDU session, an addition of an access path of an access type to the PDU session, an addition of the second 3GPP access path to the PDU session, a removal of an access path from the PDU session, a removal of an access path of an access type from the PDU session, addition of the second 3GPP access after adding the first 3GPP access to the PDU session, a removal of the second 3GPP access path from the PDU session, a change (increase, decrease) in the number of 3GPP access paths used for the PDU session, a change in the RAT type (or location area) of one of the one or more 3GPP access paths used for the PDU session, availability/unavailability change to one of the one or more 3GPP access paths used for the PDU session, stopping use of the feature of the dualsteer, activation of the use of the feature of the dualsteer and/or the like. The first policy control request trigger may allow the SMF to determine which events to monitor for dualsteer, when to contact the PCF again, when to report the events to the PCF, and/or the like. The first policy control request trigger may allow the PCF to determine which events to be notified, when to receive the information of the events from the SMF. For example, if the PCF does not support the feature of the dualsteer, the PCF may not send the first policy control request trigger associated with the dualsteer, to the SMF. For example, if the PCF support the feature of the dualsteer and/or if the PCF wants to update a SM policy for the PDU session based on the events associated with the dualsteer, the PCF may send the first policy control request trigger associated with the dualsteer, to the SMF.

In an example, in response to receiving the first Npcf MSG 1, the PCF may send a second Npcf message (e.g., Npcf MSG 2) to the SMF. For example, the Npcf MSG 2 may be at least one of a second Npcf_Policy_Authentication Create Response message, a second Npcf_SMPolicyControl Response message, a second Npcf_SMPolicyControl_Update Response message, a second Npcf_SMPolicyControl_UpdateNotify Response message, and/or the like. For example, the second Npcf message may comprise at least one of a SM policy Association ID, the first SM policy information, and/or the first policy control request trigger.

In an example, the SMF may receive from the PCF, the Npcf MSG 2. The SMF may use the information delivered by the Npcf MSG 2, to configure one or more nodes (e.g., a UPF, the RAN 1, the AMF 1). For example, because the first policy control request trigger indicates the change for dualsteer, the SMF may send to the AMF 1, a request to notify the SMF if there is the change for dualsteer. Because of the request, when there is the change for dualsteer, the AMF 1 may send a notification to the SMF, indicating the change for dualsteer. In other example, the SMF may send to the UPF, a request to monitor the change for dualsteer and to notify the SMF if there is the change for dualsteer. For example, the SMF may send a N4 MSG 2 (e.g., a second PFCP message) to the UPF. For example, the N4 MSG 2 may comprise one or more parameter (e.g., dualsteer configuration, QoS configuration (e.g., how much, which data to send via the first access path) for the first access path) to configure the PDU session, using the one or more 3GPP access paths. For example, the dualsteer configuration may indicate which 3GPP access path (e.g., the first 3GPP access) to use for communicating which data (e.g., application 1).

In an example, in response to receiving the Nsmf MSG 1, the SMF may send to the AMF 1, a Nsmf MSG 2 (a second Nsmf message). For example, the Nsmf MSG 2 may be at least one of second Nsmf_PDUSession_Create response, second Nsmf_PDUSession_Update response, second Nsmf_PDUSession_CreateSMContext response, second Nsmf_PDUSession_UpdateSMContext response, second Namf_Communication_N1N2MessageTransfer request and/or the like. For example, the second Nsmf message may comprise at least one of the S-NSSAI, the PDU Session ID, a second N2 SM container, a second N1 SM container, and/or the like. For example, the second N1 SM container may be at least one of a second PDU Session Establishment Accept message, a second PDU Session Modification Accept message, and/or the like. For example, the second N1 SM container may comprise one or more QoS parameter for the PDU session. For example, the second Nsmf message may indicate that dualsteer is accepted for the PDU session, or that multiple 3GPP access paths are accepted/allowed for the PDU session. For example, based on that multiple 3GPP access paths are accepted/allowed for the PDU session, the AMF 1 may determine whether to accept later request for addition of 3GPP access paths to the PDU session or not.

In an example, the AMF 1 may receive the Nsmf MSG 2. The AMF 1 may send to the UE, a second NAS message (e.g., NAS MSG 2). For example, the NAS MSG 2 may comprise at least one of the second N2 SM container (e.g., SM response). For example, the NAS MSG2 and/or the second N2 SM container may indicate at least one of that the PDU session is established/modified, that the PDU session is established/allowed for dualsteer, that the first access path is used for the PDU session, the identifier of the first access path, the PDU session ID, and/or the like.

In an example, the AMF 1 may send to the UE the second NAS message. For example, the second NAS message may be delivered to the first RAN via a NG MSG 2. For example, the second NAS message may be delivered to the UE via a RRC MSG 2.

In an example, after establishing the PDU session over the first access path, the UE may determine to add the second access path to the PDU session. The addition of the second access path to the PDU session may occur after the UE establishes the PDU session, and/or after the UE registers over the second access path. Based on determining to add the second access path to the PDU session, the UE may send a RRC MSG 3 (e.g., a third RRC message) to the RAN 2 (e.g., via the second 3GPP access path). For example, the RRC MSG 3 may comprise a NAS MSG 3. The RRC MSG 3 may be at least one of a third RRC setup complete message, a third RRC UL transport message, and/or the like. The NAS MSG 3 may be at least one of a third PDU Session Establish request message, a third PDU Session Modification request message, a third UL NAS transport message, and/or the like. The NAS MSG 3 may comprise at least one of a third SM message (e.g., a third PDU session associated message (e.g., a third PDU Session establishment, a third PDU session modification), a third N1 SM container), the identifier of the UE, the identifier of the PDU session, a requested QoS parameter for the PDU session, a requested QoS parameter for the second access path for the PDU session, the request for a MA PDU session, the request for dualsteer PDU session, the one or more capabilities of the UE, the identifier of the network slice for the PDU session, the DNN for the PDU session, the indication of dualsteer, the indication (information) of the second access path, and/or the like.

In an example, the RAN 2 may receive the RRC MSG 3. In response to receiving the RRC MSG 3, the RAN 2 may send a third NG MSG (NG MSG 3) to an AMF 2. For example, the AMF 2 may be the AMF 1. For example, the NG MSG 3 may comprise the NAS MSG 3 and/or a second UE location information. For example, the NG MSG 3 may be a third initial UE message. For example, the second UE location information may indicate a second cell ID of a second cell from which the UE access the network, a second identifier of a second TA of the second cell from which the UE access the network. For example, the second cell ID and/or the second identifier of the second TA may be associated with the second access path of the 3GPP access type.

In an example, the AMF 2 may receive from the RAN 2, the NG MSG 3. In response to receiving the NAS MSG 3 of the NG MSG 3, the AMF 2 may send a third Nsmf message (Nsmf MSG 3) to the SMF. For example, the third Nsmf message may comprise the NAS MSG 3 and/or one or more information element of the NAS MSG 3. For example, the third Nsmf message may be at least one of third Nsmf_PDUSession_Create request, third Nsmf_PDUSession_Update request, third Nsmf_PDUSession_CreateSMContext request, third Nsmf_PDUSession_UpdateSMContext request, third Namf_N1N2Communication_Notify and/or the like. For example, the third Nsmf message may comprise at least one of the PEI, the S-NSSAI (the identifier of the network slice for the PDU session), the PDU Session ID, the third N1 SM container, an indication of the second access path, the second UE location information (e.g., the location of the UE via the second access path, e.g., second cell Id of the second access path, RAN 2 ID of the second access path, second TA of the second access path), indication of request of MA PDU session, indication of request of dualsteer (for the PDU session), information of the one or more 3GPP access paths available (registered) for the UE, a second RAT type of the second access path, indication of the second access path. For example, the third N1 SM container may be the NAS MSG 3 and/or the one or more information element of the NAS MSG 3. The second UE location information may help the SMF to determine one or more second parameters used for the second success path. For example, the AMF 2 may receive the second UE location information from the RAN 2 via the NG MSG 3. For example, the indication of the second access path may indicate at least one of that the third N1 SM container is received via the second access path, that the third Nsmf message is associated with the second access path, that the second access path (the second 3GPP access) is requested to be added to the PDU session, and/or the like.

In an example, the SMF may receive the third Nsmf message. Based on the information in the third Nsmf message, the SMF may determine whether to update the SM policy session (association) with the PCF, and/or whether to contact the PCF. For example, because the third Nsmf message comprises the indication that the UE requests establishment of the PDU session using one or more 3GPP access path, because the third Nsmf message indicates addition of the second access path to the PDU session, and/or because the third Nsmf message requests addition of additional 3GPP access path to the PDU session, the SMF may determine that the change of for dualsteer occurs. For example, when the SMF receives the third Nsmf message, the SMF may determine whether one or more conditions indicated by the first policy control request trigger are met, and/or whether one or more events indicated by the first policy control request trigger occurs. For example, because the first policy control request trigger comprises the change for dualsteer, because the UE is requesting addition of the second access path to the PDU session, because the change for dualsteer comprises an event (e.g., second access path addition), the SMF may determine that one or more events/condition of the first policy control request trigger is met, the SMF may determine to contact the PCF, and/or the SMF may determine to send a policy update request to report the met/triggered condition.

In an example, the SMF may send to the PCF, a third Npcf message (Npcf MSG 3). For example, the Npcf MSG 3 may be at least one of third Npcf_Policy_Authentication Create Request message, third Npcf_SMPolicyControl Request message, third Npcf_SMPolicyControl_Update Request message, third Npcf_SMPolicyControl_UpdateNotify Request message, and/or the like. For example, the third Npcf message may comprise at least one of the SM policy Association ID, the identifier of the UE (e.g., SUPI), the PDU session ID, the DNN, the S-NSSAI, the second RAT type of the second access path, one or more RAT types of the one or more 3GPP access paths, the access type of the second access path, indication of support of the feature of dual steer by the UE, indication of support of the feature of dualsteer by the AMF 2, indication of support of the feature of dualsteer by the SMF, indication of subscription of the UE for the use of the feature of the dualsteer, indication that the second 3GPP access path is requested to be added, indication that the dualsteer PDU session is requested, requested QoS information of the PDU session, the second UE location information, information (e.g., the second access path is added) on the policy control request trigger condition that has been met, information of one or more 3GPP access paths registered/requested for the PDU session, and/or the like. For example, the information on the policy control request trigger condition that has been met may indicate that the second 3GPP access is added for the PDU session, that the second access path is requested to be added to the PDU session, the change for dualsteer, addition of 3GPP access, addition of the second 3GPP access, increase of 3GPP access paths for the PDU session, and/or the like.

In an example, the PCF may receive the third Npcf message. Because the third Npcf message indicates the information on the policy control request trigger condition that has been met (e.g., addition of the second 3GPP access path for the PDU session), the PCF may determine to construct/update a second SM policy information for the PDU session (e.g., PDU session related policy information) and/or a second police control request trigger. For example, the second SM policy information may comprise one or more updated information (e.g., updated PCC, updated QoS parameter, one or more QoS parameters for each 3GPP access) associated with the dualsteer. For example, the second SM policy information may comprise at least one of a second charging information (e.g., to measure network resource usage on the second access path) for the second access path, a second policy control request trigger, a second QoS characteristic (for the second access path), an updated first QoS characteristic (for the first access path), a second authorized 5QI, and/or the like. For example, the first SM policy information (e.g., before addition of the second 3GPP access) may indicate 100 Mbps as QoS requirement for the PDU session. For example, the second SM policy information (e.g., after the addition of the second 3GPP access) may indicate 500 Mbps as QoS requirement for the PDU session. For example, the second policy control request trigger may define one or more events that cause re-request of policy information (e.g., PCC rules) for the PDU session. For example, the second policy control request trigger may be similar to the first policy control request trigger.

In an example, in response to receiving the third Npcf MSG, the PCF may send a fourth Npcf message (e.g., Npcf MSG 4) to the SMF. For example, the Npcf MSG 4 may be at least one of fourth Npcf_Policy_Authentication Create Response message, fourth Npcf_SMPolicyControl Response message, fourth Npcf_SMPolicyControl_Update Response message, Npcf_SMPolicyControl_UpdateNotify Response message, and/or the like. For example, the fourth Npcf message may comprise at least one of the SM policy Association ID, the second SM policy information, and/or the second policy control request trigger.

In an example, the SMF may receive from the PCF, the Npcf MSG 4. The SMF may use information delivered by the Npcf MSG 4, to update configuration of one or more nodes (e.g., the UPF, the RAN 1, the RAN 2, the AMF 2). For example, the SMF may send a N4 MSG 4 (e.g., a PFCP message 4). For example, the N4 MSG 4 may comprise one or more parameter (e.g., dualsteer configuration, QoS configuration for the second access path, QoS configuration for the first access path) to configure UPF for the PDU session, using the one or more 3GPP access paths. For example, the dualsteer configuration may indicate an updated parameter (e.g., from 10 ms delay to 5 ms delay, from 100 Mbps to 200 Mbps) for the PDU session, considering the change (e.g., from one 3GPP access path to two 3GPP access paths) in available 3GPP access paths for the PDU session.

In an example, in response to receiving the Nsmf MSG 4, the SMF may send to the AMF 2, a Nsmf MSG 4 (a fourth Nsmf message). For example, the Nsmf MSG 4 may be at least one of fourth Nsmf_PDUSession_Create response, fourth Nsmf_PDUSession_Update response, fourth Nsmf_PDUSession_CreateSMContext response, fourth Nsmf_PDUSession_UpdateSMContext response, fourth Namf_Communication_N1N2MessageTransfer request and/or the like. For example, the fourth Nsmf message may comprise at least one of the S-NSSAI, the PDU Session ID, a fourth N2 SM container, a fourth N1 SM container, and/or the like. For example, the fourth N1 SM container may be at least one of fourth PDU Session Establishment Accept message, fourth PDU Session Modification Accept message, and/or the like. For example, the fourth N1 SM container may comprise one or more QoS parameter for the PDU session, a first one or more QoS parameter for the first access path of the PDU session, a second one or more QoS parameters for the second access path of the PDU session.

In an example, the AMF 2 may receive the Nsmf MSG 4. The AMF 2 may send to the UE, a fourth NAS message (e.g., NAS MSG 4). For example, the NAS MSG 4 may comprise at least one of the fourth N2 SM container (e.g., fourth SM response). For example, the NAS MSG 4 and/or the fourth N2 SM container may indicate at least one of that the PDU session is established/modified, that the PDU session is established/allowed for dualsteer, that the second access path is added/allowed for use for the PDU session, the identifier of the second access path, the PDU session ID, and/or the like.

In an example, the AMF 2 may send to the UE the fourth NAS message. For example, the fourth NAS message may be delivered to the second RAN via a NG MSG 4. For example, the fourth NAS message may be delivered to the UE via a RRC MSG 4.

The example of the FIG. 22 may assist a network to update configuration of one or more network node to better serve a PDU session, by controlling information to deliver.

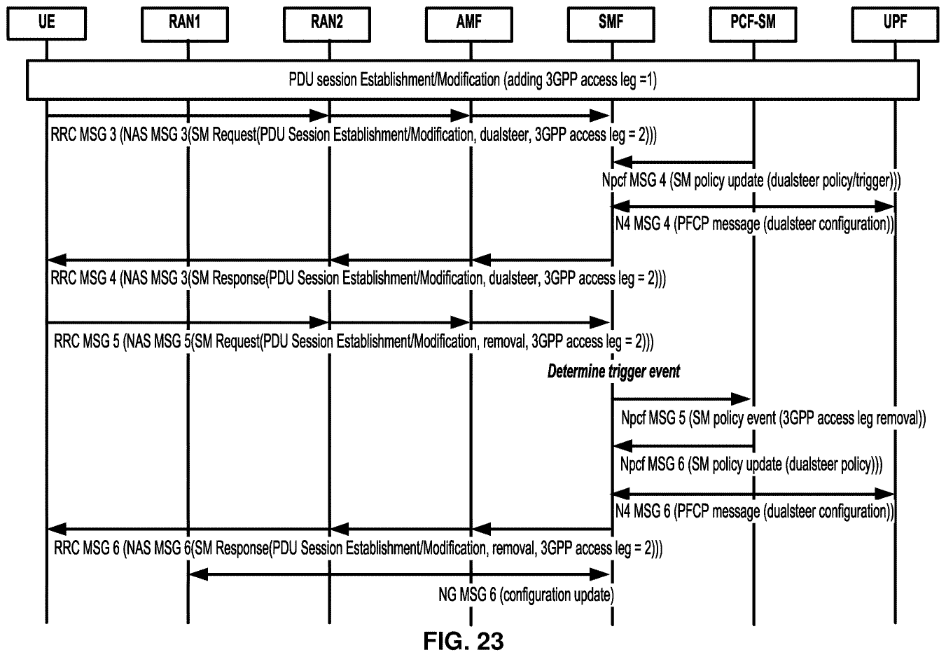

FIG. 23 depicts one example embodiment of the present disclosure. In an example, a SMF may receive an information of one or more policy triggers. The one or more policy triggers may indicate removal of a 3GPP access paths from a plurality of 3GPP access paths for a PDU session. This may help the PCF to determine when to update policy parameters for the PDU session. For brevity, based on the other part of the present disclosure, redundant details will be omitted.

In an example, the UE may perform the first registration via the first RAN (e.g., RAN 1) and/or the second registration via the second RAN (e.g., RAN 2).

In an example, the UE may establish the PDU session. For the PDU session, the UE may add the first access path and/or the second access path to the PDU session. For this PDU session, the PCF may send a policy control request trigger (e.g., the first policy control request trigger, the second policy control request trigger) to the SMF. The example of FIG. 22 may be used. Reverting to FIG. 23, the UE may send a RRC MSG 5, to remove the second access path.

In an example, the removal of the second access path may be caused in various scenarios. For example, the UE may move out of a second coverage of the second access path. For example, when a satellite revolves around the earth, the coverage of radio signal transmitted via the satellite may cover a first area (e.g., city A) for a first time (e.g., PM09:30-PM10:00)., and/or may not cover the first area for a second time (e.g., PM10:00-PM10:30). This may cause the second access path not available to the UE. In other example, the UE may experience a battery power shortage, and/or the UE may determine not to use the second access path (e.g., the second access path may consume more power than the first access path).

In an example, the UE may send the RRC MSG 5 to indicate removal of the second access path from the PDU session. The RRC MSG 5 may be at least one of a fifth RRC setup complete message, a fifth RRC UL transport message, and/or the like. The RRC MSG 5 may comprise a NAS message 5 (NAS MSG 5). The NAS MSG 5 may be at least one of a fifth PDU Session release request message, a fifth PDU Session Modification request message, a fifth UL NAS transport message, and/or the like. The NAS MSG 5 may comprise at least one of a fifth SM message (e.g., a fifth PDU session associated message (e.g., a fifth PDU Session establishment request message, a fifth PDU session modification request message), a fifth N1 SM container), the identifier of the UE, the identifier (e.g., PDU session ID) of the PDU session, a cause value indicating a reason of release, indication indicating that the second access path is released. In other example, deactivation may be indicated instead of release.

In an example, the AMF 1 may receive the NAS MSG 5. For example, the AMF 1 may receive the NAS MSG 5 via a NG MSG 5 from the RAN 1. The AMF 1 may send the NAS MSG 5 or one or more information element (e.g., the fifth N1 SM container) of the NAS MSG 5 or one or more information element (e.g., the second access path) of the NG MSG 5 to the SMF. For example, the AMF 1 may use a Nsmf MSG 5 to deliver the NAS MSG 5, and/or the one or more information element of NG MSG 5, and/or the one or more information element of the NAS MSG 5, to the SMF.

In an example, the SMF may receive the Nsmf MSG 5. Based on the information of the Nsmf MSG 5, the SMF may determine whether to update the SM policy session (association) with the PCF, and/or whether to contact the PCF. For example, because the fifth Nsmf message comprises the indication that the UE requests release (e.g., release, deactivation, removal) of the second access path (e.g., second 3GPP access) from the PDU session (which is using a plurality of 3GPP accesses), because the fifth Nsmf message indicates removal of the second access path from the plurality of 3GPP access for the PDU session, and/or because the fifth N1 SM container requests removal of additional (e.g., secondary) 3GPP access path from the PDU session, the SMF may determine that the change of for dualsteer occurs. For example, when the SMF receives the fifth Nsmf message, the SMF may determine whether one or more conditions indicated by the first/second policy control request trigger are met, and/or whether one or more events indicated by the first/second policy control request trigger occurs. For example, because the first/second policy control request trigger comprises the change for dualsteer, because the UE is requesting release of the second access path from the PDU session, because the UE requests removal of the second access path from the plurality of 3GPP access paths, and/or because the change for dualsteer comprises an event (e.g., second access path removal), the SMF may determine that one or more events/condition of the first/second policy control request trigger is met, the SMF may determine to contact the PCF, and/or the SMF may determine to send a second policy update request to report the met/triggered condition.

In an example, the SMF may send to the PCF, a fifth Npcf message (Npcf MSG 5). For example, the Npcf MSG 5 may be at least one of fifth Npcf_Policy_Authentication Create Request message, fifth Npcf_SMPolicyControl Request message, fifth Npcf_SMPolicyControl_Update Request message, fifth Npcf_SMPolicyControl_UpdateNotify Request message, and/or the like. For example, the fifth Npcf message may comprise at least one of the SM policy Association ID, the identifier of the UE (e.g., SUPI), the PDU session ID, the DNN, the S-NSSAI, the second RAT type of the second access path, one or more RAT types of the one or more 3GPP access paths, the access type of the second access path, indication of support of the feature of dual steer by the UE, indication of support of the feature of dualsteer by the AMF 1, indication of subscription of the UE for the use of the feature of the dualsteer, indication that the second 3GPP access path is requested to be released, indication that update of the dualsteer PDU session is requested, requested QoS information of the PDU session, the second UE location information, information (e.g., the second access path is released) on the policy control request trigger condition that has been met, information of one or more 3GPP access paths removed for the PDU session, and/or the like. For example, the information on the policy control request trigger condition that has been met may indicate that the second 3GPP access is deactivated (e.g., released/removed) for the PDU session, that the second access path is requested to be released from the PDU session, the change for dualsteer, removal of one of one or more 3GPP access, release of the second 3GPP access, decrease of 3GPP access paths for the PDU session, and/or the like.

In an example, the PCF may receive the fifth Npcf message. Because the fifth Npcf message indicates the information on the policy control request trigger condition that has been met (e.g., release of the second 3GPP access path for the PDU session), the PCF may determine to construct/update a third SM policy information for the PDU session (e.g., PDU session related policy information) and/or a third police control request trigger. For example, the third SM policy information may comprise one or more updated information (e.g., updated PCC, updated QoS parameter, one or more QoS parameters for each 3GPP access) associated with the dualsteer. For example, the third SM policy information may comprise at least one of a third charging information (e.g., to measure network resource usage on a remaining 3GPP access path) for the PDU session, a third policy control request trigger, a third QoS characteristic (for the remaining 3GPP access path), an updated first QoS characteristic (for the first access path), a third authorized 5QI, and/or the like. For example, the second SM policy information (e.g., before removal of the second 3GPP access) may indicate 1000 Mbps as QoS requirement for the PDU session. For example, the third SM policy information (e.g., after the removal of the second 3GPP access) may indicate 100 Mbps as QoS requirement for the PDU session. For example, the third policy control request trigger may define one or more events that cause re-request of policy information (e.g., PCC rules) for the PDU session. For example, the third policy control request trigger may be similar to the second policy control request trigger.

In an example, in response to receiving the fifth Npcf MSG, the PCF may send a sixth Npcf message (e.g., Npcf MSG 6) to the SMF. For example, the Npcf MSG 6 may be at least one of sixth Npcf_Policy_Authentication Create Response message, sixth Npcf_SMPolicyControl Response message, sixth Npcf_SMPolicyControl_Update Response message, six Npcf_SMPolicyControl_UpdateNotify Response message, and/or the like. For example, the sixth Npcf message may comprise at least one of the SM policy Association ID, the third SM policy information, and/or the third policy control request trigger.

In an example, the SMF may receive from the PCF, the Npcf MSG 6. The SMF may use information delivered by the Npcf MSG 6, to update configuration of one or more nodes (e.g., the UPF, the RAN 1, the RAN 2, the AMF 1). For example, the SMF may send a N4 MSG 6 (e.g., a PFCP message 6). For example, the N4 MSG 6 may comprise one or more parameter (e.g., dualsteer configuration, deletion of QoS configuration for the second access path, QoS configuration for the first access path) to configure UPF for the PDU session, using the one or more 3GPP access paths. For example, the dualsteer configuration may indicate an updated parameter (e.g., from 5 ms delay to 10 ms delay, from 200 Mbps to 100 Mbps) for the PDU session, considering the change (e.g., from two 3GPP access path to one 3GPP access paths) in available 3GPP access paths for the PDU session.

In an example, in response to receiving the Nsmf MSG 6, the SMF may send to the AMF 1, a Nsmf MSG 6 (a sixth Nsmf message). For example, the Nsmf MSG 6 may be at least one of sixth Nsmf_PDUSession_Create response, sixth Nsmf_PDUSession_Update response, sixth Nsmf_PDUSession_CreateSMContext response, sixth Nsmf_PDUSession_UpdateSMContext response, sixth Namf_Communication_N1N2MessageTransfer request and/or the like. For example, the sixth Nsmf message may comprise at least one of the S-NSSAI, the PDU Session ID, a sixth N2 SM container, a sixth N1 SM container, and/or the like. For example, the sixth N1 SM container may be at least one of sixth PDU Session Establishment Accept message, sixth PDU Session Modification Accept message, and/or the like. For example, the sixth N1 SM container may comprise one or more QoS parameter for the PDU session, a first one or more QoS parameter for the first access path of the PDU session.

In an example, the AMF 1 may receive the Nsmf MSG 6. The AMF 1 may send to the UE, a sixth NAS message (e.g., NAS MSG 6). For example, the NAS MSG 6 may comprise at least one of the sixth N1 SM container (e.g., sixth SM response). For example, the NAS MSG 6 and/or the sixth N2 SM container may indicate at least one of that the PDU session is established/modified, that the second access path is released for the PDU session, the identifier of the second access path, the PDU session ID, and/or the like.

In an example, the AMF 1 may send to the UE the sixth NAS message. For example, the sixth NAS message may be delivered to the RAN 1 (or the RAN 2) via a NG MSG 6. For example, the sixth NAS message may be delivered to the UE via a RRC MSG 6. For example, the AMF 1 may send another N2 message to the RAN 2 to remove resources allocated for the second access path.

The example of the FIG. 23 may assist a network to update configuration of one or more network node to better serve a PDU session. E.g., when a number of 3GPP access paths for the PDU session decreases, the QoS parameter is timely updated.

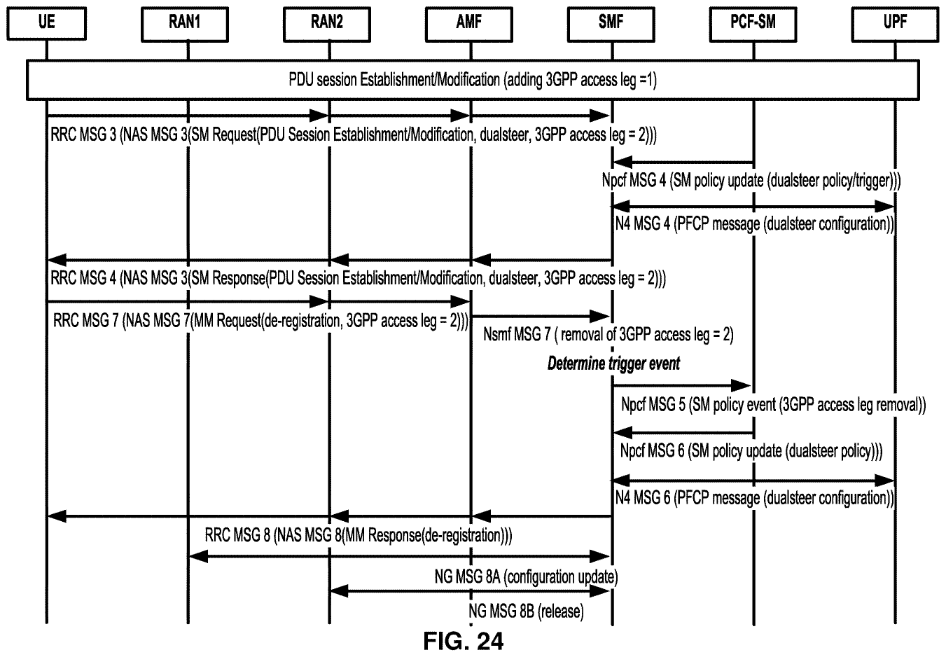

FIG. 24 depicts one example embodiment of the present disclosure. In an example, a SMF may receive an information of one or more policy triggers (e.g., policy control request trigger). The SMF may receive information (e.g., information of change) of the one or more 3GPP access paths from an AMF. This may help the SMF to determine when to request update of policy parameters for the PDU session. For brevity, based on the other part of the present disclosure, redundant details will be omitted.

In an example, the UE may perform the first registration via the first RAN (e.g., RAN 1) and/or the second registration via the second RAN (e.g., RAN 2). E.g., the UE may be registered via both first and second 3GPP access paths.

In an example, the UE may establish the PDU session. For the PDU session, the UE may add the first access path and/or the second access path to the PDU session. For this PDU session, the PCF may send a policy control request trigger (e.g., the first policy control request trigger, the second policy control request trigger) to the SMF. The example of FIG. 22 may be used. Reverting to FIG. 24, the UE may send a RRC MSG 7, to remove the second access path.

In an example, the UE may send the RRC MSG 7 to indicate de-registration (or unavailability) of the second access path. The RRC MSG 7 may be at least one of a seventh RRC setup complete message, a seventh RRC UL transport message, and/or the like. The RRC MSG 7 may comprise a NAS message 7 (NAS MSG 7). The NAS MSG 7 may be at least one of a seventh registration request message, a seventh de-registration request message, a seventh UL NAS transport message, and/or the like. The NAS MSG 7 may comprise at least one of a seventh MM message (e.g., a seventh registration associated message (e.g., a seventh registration request message, a seventh de-registration request message, a seventh status report message)), the identifier of the UE, a cause value indicating a reason of deregistration of the second access path, a cause value indicating a reason of removal of the second access path, indication indicating that the second access path is de-registered, and/or indication that the second access path is not available. In other example, deactivation may be indicated instead of release.

In an example, the AMF 1 (or the AMF 2) may receive the NAS MSG 7. For example, the AMF 1 may receive the NAS MSG 7 via a NG MSG 7 from the RAN 1 (or via RAN 2). For example, because the NAS MSG 7 indicates de-registration of the second access path (e.g., removal of the second access path), the AMF 1 may determine (identify) one or more PDU sessions using the second access path. For example, the AMF 1 may determine that the deregistration of the second access path impacts the one or more PDU sessions (e.g., the PDU session). For example, if the AMF 1 may determine that the second access path is not available, the AMF may determine that deregistration of the second access path is required, and/or that the AMF needs to notify the SMF of unavailability/release of the second access path.

In an example, the AMF 1 may send to the SMF, a Nsmf MSG 7 to indicate the release of the second access path for the PDU session, and/or to indicate unavailability of the second access path for the UE. For example, the Nsmf MSG 7 may be one of seventh Namf_EventExposure_Notify message, seventh Namf_AMFStatusChangeNotify message, seventh Namf_Communication_N1N2MessageTransfer request message, Nsmf_PDUSession_UpdateSMContext request, and/or the like. For example, the Nsmf MSG 7 may comprise an indication. For example, the indication may indicate at least one of the de-registration (removal, release) of the second access path, one or more available 3GPP accesses (e.g., the first access path), one or more unavailable 3GPP accesses (e.g., the second access path), the cause of removal of the second access path, the PDU session ID, an indication that the second access path is not available and/or the like.

In an example, the SMF may receive the Nsmf MSG 7. Based on the information of the Nsmf MSG 7, the SMF may determine whether to update the SM policy session (association) with the PCF, and/or whether to contact the PCF. For example, because the seventh Nsmf message (e.g., the Nsmf MSG 7) comprises the indication that the second access path is released, the SMF may determine that the change for dualsteer occurs. For example, when the SMF receives the seventh Nsmf message, the SMF may determine whether one or more conditions indicated by the first/second policy control request trigger are met, and/or whether one or more events indicated by the first/second policy control request trigger occurs. For example, because the first/second policy control request trigger comprises the change for dualsteer, because the AMF indicates that the second access path among the one or more 3GPP access path is removed, and/or because the change for dualsteer comprises an event (e.g., second access path removal), the SMF may determine that one or more events/condition of the first/second policy control request trigger is met, the SMF may determine to contact the PCF, and/or the SMF may determine to send a second policy update request to report the met/triggered condition.

In an example, the SMF may send to the PCF, the fifth Npcf message (Npcf MSG 5). In an example, in response to receiving the fifth Npcf MSG, the PCF may send the sixth Npcf message (e.g., Npcf MSG 6) to the SMF. In an example, the SMF may receive from the PCF, the Npcf MSG 6. The SMF may use information delivered by the Npcf MSG 6, to update configuration of one or more nodes (e.g., the UPF, the RAN 1, the RAN 2, the AMF 1).

In an example, in response to receiving the Nsmf MSG 7, the SMF may send to the AMF 1, a Nsmf MSG 8 (e.g., eighth Nsmf message). For example, the Nsmf MSG 8 may be at least one of eighth Namf_EventExposure_Notify message, eighth Namf_AMFStatusChangeNotify message, eighth Namf_Communication_N1N2MessageTransfer request message, eighth Nsmf_PDUSession_UpdateSMContext request, and/or the like. For example, the Nsmf MSG 8 may comprise at least one of the S-NSSAI, the PDU Session ID, one or more eighth N2 SM containers, a eighth N1 SM container, and/or the like. For example, the eighth N1 SM container may comprise at least one of eighth PDU Session Modification Command/Request message, and/or the like. For example, the eighth N1 SM container may comprise one or more QoS parameter for the PDU session, a first one or more QoS parameter for the first access path of the PDU session, may indicate removal of one or more configuration for the second access path. For example, the one or more eighth N2 SM containers may comprise updated configuration information for the RAN 1 and/or RAN 2. For example, a first eighth N2 SM container may be delivered to the RAN 1. The first eighth N2 SM container may indicate to the RAN 1 of a first updated information for the PDU Session. For example, the first updated information may be a first QoS profile/parameters (e.g., QoS, N3 parameters) for the PDU session. For example, a second eighth N2 SM container may be delivered to the RAN 2. For example, the second eighth N2 SM container may indicate the RAN 2 to release resources (e.g., resources allocated via the second access path) allocated for the PDU session.

In an example, the AMF 1 may receive the Nsmf MSG 8. The AMF 1 may send to the UE, the eighth NAS message (e.g., NAS MSG 8). For example, the NAS MSG 8 may comprise at least one of the eighth N1 SM container (e.g., eighth SM response), an eighth MM message (e.g., an eighth registration associated message (e.g., eighth registration accept message, an eighth deregistration accept message). For example, the eighth NAS message may indicate that the second access path is deregistered/removed for the PDU session (and/or UE), and/or that the PDU session is updated not to use the second access path. In an example, the AMF 1 may send to the RAN 1, the first eighth N2 SM container. In an example, the AMF 1 may send to the RAN 2, the second eighth N2 SM container. In response to receiving the second eighth N2 SM container, the RAN 2 may release resources for the PDU session for the UE.

In an example, the AMF 1 may send to the UE the eighth NAS message. For example, the eighth NAS message may be delivered to the RAN 1 (or the RAN 2) via a NG MSG 8. For example, the eighth NAS message may be delivered to the UE via a RRC MSG 8. For example, the AMF 1 may send another N2 message to the RAN 2 to remove resources allocated for the second access path. For example, the eighth NAS message may be the sixth NAS message.

In an example, the AMF 1 may send to the SMF, the Nsmf MSG 7, without receiving the NAS MSG 7. For example, the AMF 1 may monitor whether the UE performs any access to the network. For example, the AMF 1 may run a timer for monitoring. If the AMF 1 does not detect any activity over the second access path, the AMF 1 may determine that a connection to the UE via the second access path is lost and/or that the UE is not reachable (available) via the second access path. Based on this determination, the AMF 1 may send a notification to the SMF that the UE is not available via the second access path. The SMF and/or the AMF may start to release/deactivate/remove the second 3GPP access path from the PDU session, while keeping the first 3GPP access path for the PDU session.

The example of the FIG. 24 may assist a SMF to update configuration of one or more network node, in response to information received from an AMF.

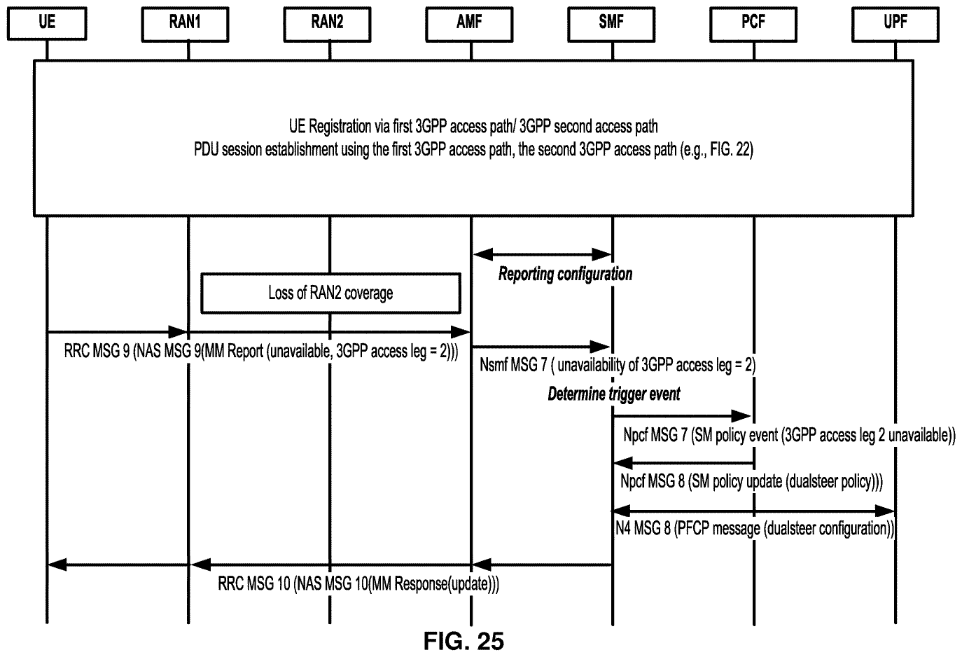

FIG. 25 depicts one example embodiment of the present disclosure. In an example, a UE may detect some of one or more 3GPP access paths used for a PDU session is not available, and/or may send a notification. This may help the SMF to determine whether update is needed for the PDU session. For brevity, based on the other part of the present disclosure, redundant details will be omitted.

In an example, the UE may perform the first registration via the first RAN (e.g., RAN 1) and/or the second registration via the second RAN (e.g., RAN 2).

In an example, the UE may establish the PDU session. For the PDU session, the UE may add the first access path and/or the second access path to the PDU session. For this PDU session, the PCF may send a policy control request trigger (e.g., the first policy control request trigger, the second policy control request trigger) to the SMF. The UE may send the RRC MSG 1, receive the RRC MSG 2, send the RRC MSG 3 and/or receive the RRC MSG 4. The PCF/AMF/SMF may exchange Npcf MSG 1/2/3/4, Nsmf MSG 1/2/3/4, and/or the like. The example of FIG. 22 may be used.

Reverting to FIG. 25, the SMF may need to get information of at least one 3GPP access path. For example, the SMF may send a Namf request to the AMF, requesting the AMF to send to the SMF, an information of change in the at least one 3GPP access. For example, the information of change may be at least one of, unavailability (e.g., become unavailable from available) of the at least one 3GPP access, availability (e.g., become available from unavailable) of the at least one 3GPP access, area change (e.g., gNB change, cell change, TA change, frequency change) of the at least one 3GPP access, quality change (e.g., backhaul type change (e.g., satellite <->non-satellite), congestion in the backhaul, fulfilled QoS, and/or the like) of the at least one 3GPP access path, and/or the like. For example, the Namf request may be Namf event subscription request message and/or the like. For example, if the AMF determine that an event indicated by the information of change occurs, the AMF may report the event to the SMF. For example, the AMF may use the Nsmf 7 MSG to report the event. For example, to determine that the event occurs, the AMF may send a reporting request to at least one of the RAN1, the RAN2, and/or the UE. For example, the reporting request may request at least one of the RAN1, the RAN2, and/or the UE, to send a reporting to the AMF, if at least one event of the information of change occurs. For example, when the at least one event occurs, the at least one of the RAN1, the RAN2 and/or the UE may send to the AMF, the reporting. Similarly, the SMF may send the reporting request to the UPF and receives the reporting, to determine whether there is the change.

In an example, the PDU session may be configured to use a plurality of 3GPP access paths. For example, the plurality of 3GPP access paths may comprise the first access path and/or the second access path. In an example, the UE may determine that a first one or more 3GPP access paths of the plurality of 3GPP access paths are not available. For example, the first one or more 3GPP access paths may comprise the second access path. For example, when the UE moves out of the coverage of the second access path, the UE may determine that the second access path is not available and/or that the UE is out of coverage of the second access path.

In an example, the UE may send a RRC MSG 9, to indicate unavailability of the second 3GPP access path (the second access path). The RRC MSG 9 may be at least one of a 9^{th} RRC setup complete message, a 9^{th} RRC UL transport message, and/or the like. The RRC MSG 9 may comprise a NAS message 9 (NAS MSG 9). The NAS MSG 9 may comprise at least one of information of one or more 3GPP accesses that are not available, an indication indicating that the second 3GPP access path is not available, the identifier of the second access path, a cause value indicating a reason of release (unavailability), indication indicating that the second access path needs to be released, and/or the like. In other example, deactivation may be indicated instead of release.

In an example, the AMF may receive the NAS MSG 9. Because the NAS MSG 9 indicates the unavailability of the second 3GPP access path, the AMF may determine to remove (or release, deactivate) one or more PDU sessions using the second access path, may determine to remove the second access path from the one or more PDU sessions using the second access path, and/or the like. For example, the AMF may send the Nsmf MSG 7. The SMF may send Npcf MSG 7. The SMF may receive the Npcf MSG 8. The SMF may send the Nsmf MSG 8 to AMF. For example, the example of FIG. 24 may be used.

Reverting back to FIG. 25, the AMF may receive the Nsmf MSG 8. In response to receiving the Nsmf MSG 8 and/or the NAS MSG 9, the AMF may send a NAS MSG 10 to the UE. For example, the NAS MSG 10 may be similar to the NAS MSG 8. For example, the NAS MSG 10 may indicate at least one of deregistration of the second access path, updated configuration of the PDU session, and/or the like. In other example, using similar mechanism as described above, similarly, when a 3GPP access path become from unavailable to available, the UE may send a message to the AMF (or SMF, UPF), to indicate the availability (e.g., of the second 3GPP access path). This may help the SMF and/or the PCF to update a parameter for the use of dualsteer.

The example of FIG. 25 may help the network nodes to update configuration of a UE (or a PDU session) using multiple 3GPP access paths, in response to whether a 3GPP access path of the multiple access paths becomes available/unavailable.

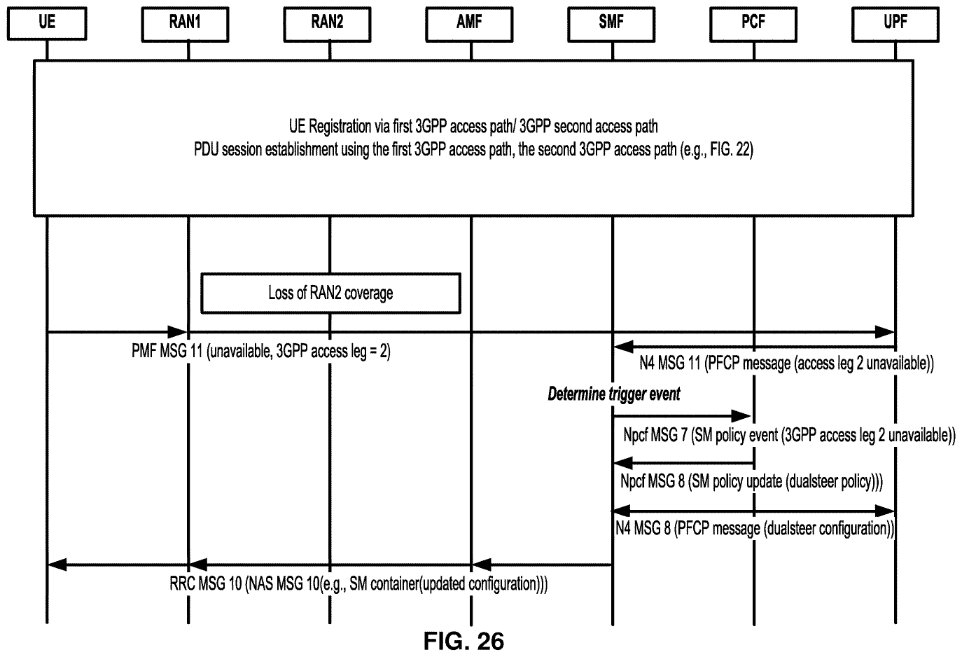

FIG. 26 depicts one example embodiment of the present disclosure. In an example, a UE may detect some of one or more 3GPP access paths used for a PDU session is not available, may send a notification message to a PMF (performance measurement function) in a UPF. This may help the SMF to receive information on whether update is needed for the PDU session. For brevity, based on the other part of the present disclosure, redundant details will be omitted.

In an example, the UE may perform the first registration via the first RAN (e.g., RAN 1) and/or the second registration via the second RAN (e.g., RAN 2).

In an example, the UE may establish the PDU session. For the PDU session, the UE may add the first access path and/or the second access path to the PDU session. For this PDU session, the PCF may send a policy control request trigger (e.g., the first policy control request trigger, the second policy control request trigger) to the SMF. The UE may send the RRC MSG 1, receive the RRC MSG 2, send the RRC MSG 3 and/or receive the RRC MSG 4. The PCF/AMF/SMF may exchange Npcf MSG 1/2/3/4, Nsmf MSG 1/2/3/4, and/or the like. The example of FIG. 22 may be used.

Reverting to FIG. 26, in an example, the PDU session may be configured to use a plurality of 3GPP access paths. For example, the plurality of 3GPP access paths may comprise the first access path and/or the second access path. In an example, the UE may determine that the second access path is not available and/or that the UE is out of coverage of the second access path.

In an example, the UE may send a protocol measurement function (PMF) MSG 11 to the UPF (or the PMF collocated with the UPF). For example, the UE may use the PDU session to send the PMF MSG 11. For example, the UE may send the PMF MSG 11 via an available 3GPP access path (e.g., the first access path if the second access path is not available). For example, the PMF MSG 11 may comprise information similar to the NAS MSG 9. For example, the PMF MSG 11 may comprise at least one of information of one or more 3GPP accesses that are not available, an indication indicating that the second 3GPP access path is not available, an indication that the first 3GPP access path is available, the identifier of the second access path, and/or the like.

In an example, the PMF may receive the PMF MSG 11. Because the PMF MSG 11 indicates the unavailability of the second 3GPP access path, the PMF (or the UPF) may determine to send N4 MSG 10 to the SMF. For example, the PMF (or the UPF) may send the N4 MSG 10, if the SMF configured the PMF (or the UPF) to send a report. For example, the N4 MSG 10 may indicate that the second access path (e.g., the second 3GPP access) is not available. In response to receiving the N4 MSG 10, and based on the policy control message (e.g., policy control request trigger), the SMF may send Npcf MSG 7 to the PCF. The SMF may receive the Npcf MSG 8 from the PCF. The SMF may send the Nsmf MSG 8 or the Nsmf MSG 6 to AMF. For example, the SMF may send the N4 MSG 8 or the N4 MSG 6 to the UPF, to update configuration of the UPF (and/or the PMF). For example, the AMF may receive the Nsmf MSG 8 or the Nsmf MSG 6. For example, the AMF may send the NAS MSG 10, the NAS MSG 8, or the NAS MSG 6 to the UE. For example, the example of FIG. 25 or FIG. 24 or FIG. 23 may be used.

Reverting back to FIG. 26, the UE may receive an updated configuration (e.g., decreased QoS, change of QoS parameter, etc.) for the PDU session.

The example of FIG. 26 may help the network nodes to quickly determine change in the available 3GPP access paths for a dualsteer PDU session.

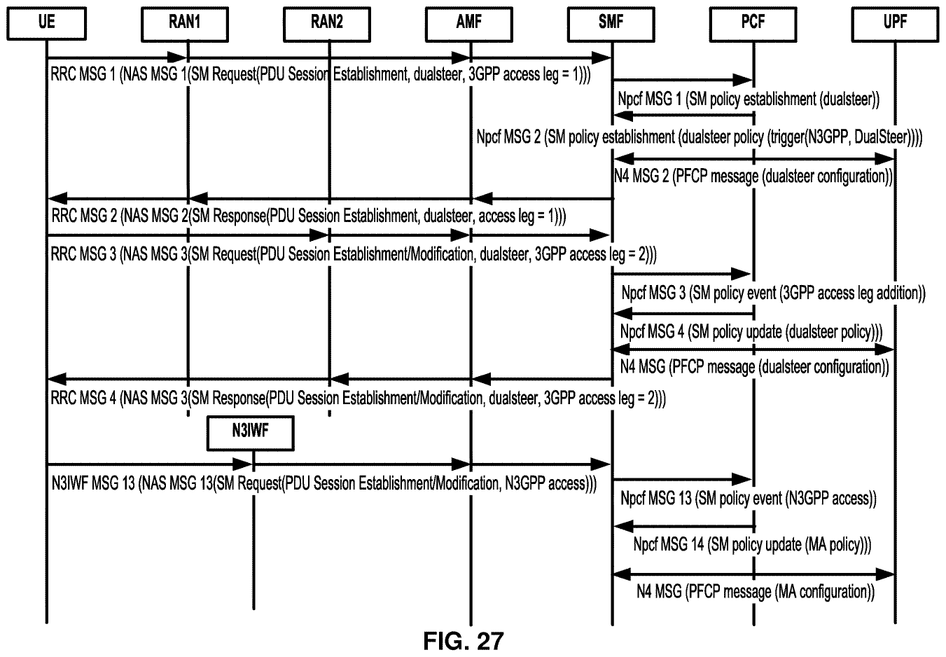

FIG. 27 depicts one example embodiment of the present disclosure. In an example, a UE may establish a PDU session using a first plurality of 3GPP accesses and/or a first plurality of N3GPP access, to further increase QoS (e.g., data-rate, reliability) of a PDU session. For brevity, based on the other part of the present disclosure, redundant details will be omitted.

In an example, the UE may perform the first registration via the first RAN (e.g., RAN 1) and/or the second registration via the second RAN (e.g., RAN 2).

In an example, the UE may establish the PDU session. For the PDU session, the UE may add the first access path and/or the second access path to the PDU session. For this PDU session, the PCF may send a policy control request trigger (e.g., the first policy control request trigger, the second policy control request trigger) to the SMF. The UE may send the RRC MSG 1, receive the RRC MSG 2, send the RRC MSG 3 and/or receive the RRC MSG 4. The PCF/AMF/SMF may exchange Npcf MSG 1/2/3/4, Nsmf MSG 1/2/3/4, and/or the like. The example of FIG. 22 may be used. For example, the first policy control request trigger and/or the second policy control request trigger may comprise an event associated with the N3GPP access (e.g., addition of N3GPP access, removal of N3GPP access).

Reverting to FIG. 27, in an example, the UE may communicate one or more data packets via the PDU session. For example, for the PDU session, a first number of data packets may be delivered via the first 3GPP access path and/or a second number of data packets may be delivered via the second 3GPP access path.

In an example, the UE may determine to add to the PDU session, a N3GPP access path. In other example, the UE may determine to add the N3GPP access path before adding the second 3GPP access path. For example, to increase reliability of data communication and/or to increase data rate for the PDU session, the UE may determine to add the N3GPP access path to the PDU session. For example, when the UE establishes the PDU session (e.g., when the UE sends the first NAS message), the UE may indicate that the UE requests to PDU session to support one or more 3GPP access paths and/or one or more N3GPP access paths. For example, the SMF may indicate to the UE, e.g., via the NAS MSG 2, allowance of the PDU session using the one or more 3GPP access paths and/or the one or more N3GPP access paths. Because the UE receives the allowance, the UE may determine to add the N3GPP access path. The UE may send a N3IWF MSG 13 to a N3IWF. For example, the N3IWF MSG 13 may be an EAP message, a IPSEC message, and/or the like. For example, the N3IWF MSG 13 may comprise a NAS MSG 13. For example, The NAS MSG 13 may be at least one of a thirteenth PDU Session Establish request message, a thirteenth PDU Session Modification request message, a thirteenth UL NAS transport message, and/or the like. The NAS MSG 13 may comprise at least one of a thirteenth SM message (e.g., a thirteenth PDU session associated message (e.g., a thirteenth PDU Session establishment request message, a thirteenth PDU session modification request message), a thirteenth SM container), the identifier of the UE, the identifier (e.g., PDU session ID) of the PDU session, a thirteenth requested QoS parameter, the request for a MA PDU session, the request for dualsteer session, the indication of dualsteer, an indication (e.g., that the N3GPP access path is used for the request, an identifier of the N3GPP access path, and/or the like) of the N3GPP access path, an N3GPP access type, and/or the like.

In an example, the AMF may receive the NAS MSG 13 via a NG MSG 13. For example, the NG MSG 13 may comprise at least one of the NAS MSG 13, a third UE location information (e.g., the location information associated with the N3GPP access), indication of the N3GPP access type, indication of the N3GPP access path, and/or the like.

In an example, in response to receiving the NAS MSG 13, the AMF may send a Nsmf MSG 13 to the SMF. For example, the Nsmf MSG 13 may comprise at least one of the NAS MSG 13, one or more information of the NAS MSG 13, indication of the N3GPP access path, indication of the N3GPP access type and/or the like.

In an example, the SMF may receive the Nsmf MSG 13. Based on the information in the Nsmf MSG 13, the SMF may determine whether to update the SM policy session (association) with the PCF, and/or whether to request updated policy from the PCF, and/or to send notification to the PCF. For example, because the Nsmf MSG 13 comprises the indication that the UE requests establishment of the PDU session using the one or more 3GPP access and/or the N3GPP access, and/or because the Nsmf MSG 13 indicates addition of the N3GPP access path to the PDU session, the SMF may determine that the change of for dualsteer occurs. For example, when the SMF receives the Nsmf MSG 13, the SMF may determine whether one or more conditions indicated by the first (or the second) policy control request trigger are met, and/or whether one or more events indicated by the first (or the second) policy control request trigger occurs. For example, because the first (or the second) policy control request trigger comprises the change for dualsteer, because the UE is requesting addition of the N3GPP access path to the PDU session (allowed for dualsteer), because the change for dualsteer comprises an event (e.g., N3GPP access path addition), the SMF may determine that one or more events/condition of the first (or the second) policy control request trigger is met, the SMF may determine to contact the PCF, and/or the SMF may determine to send a policy update request to report the met/triggered condition.

In an example, the SMF may send to the PCF, a Npcf MSG 13. For example, the Npcf MSG 13 may be at least one of thirteenth Npcf_Policy_Authentication Create Request message, thirteenth Npcf_SMPolicyControl Request message, thirteenth Npcf_SMPolicyControl_Update Request message, thirteenth Npcf_SMPolicyControl_UpdateNotify Request message, and/or the like. For example, the Npcf MSG 13 may comprise at least one of the SM policy Association ID, the identifier of the UE (e.g., SUPI), the PDU session ID, the DNN, the S-NSSAI, the RAT type (e.g., WIFI, fixed broadband, etc.) of the N3GPP access path, the one or more RAT types of the one or more 3GPP access paths, the access type of the N3GPP access path, indication of support of the feature of dual steer by the UE, indication of support of the feature of dualsteer by the SMF, indication that the N3GPP access path is requested to be added, the indication that the dualsteer PDU session is requested, the requested QoS information of the PDU session, the third UE location information, information (e.g., the N3GPP access path is added) of the policy control request trigger condition that has been met, information of one or more 3GPP access paths registered/requested for the PDU session, information of one or more N3GPP access paths registered/requested for the PDU session, and/or the like. For example, the information on the policy control request trigger condition that has been met may indicate that the N3GPP access is added for the PDU session, that the N3GPP access path is requested to be added to the PDU session, the change for dualsteer, addition of N3GPP access, addition of the N3GPP access, increase of N3GPP access paths for the PDU session, and/or the like.

In an example, the PCF may receive the Npcf MSG 13. Based on the Npcf MSG 13, the PCF may determine that the N3GPP access path is added to the PDU session, may determine to construct/update a fourth SM policy information for the PDU session (e.g., PDU session related policy information, e.g., PCC rule for the one or more 3GPP access and/or for the N3GPP access) and/or a fourth police control request trigger. For example, the fourth SM policy information may comprise one or more updated information associated with the dualsteer. For example, the fourth policy control request trigger may be similar to the second policy control request trigger.

In an example, in response to receiving the Npcf MSG 13, the PCF may send a Npcf MSG 14 to the SMF. For example, the Npcf MSG 14 may comprise at least one of the SM policy Association ID, the fourth SM policy information, and/or the fourth policy control request trigger.

In an example, the SMF may receive the Npcf MSG 14. Based on the Npcf MSG 14, the SMF may update configuration of the UPF and/or the UE.

The example of FIG. 27 may support configuration update for a PDU session using a plurality of 3GPP access paths and/or one or more N3GPP access paths.

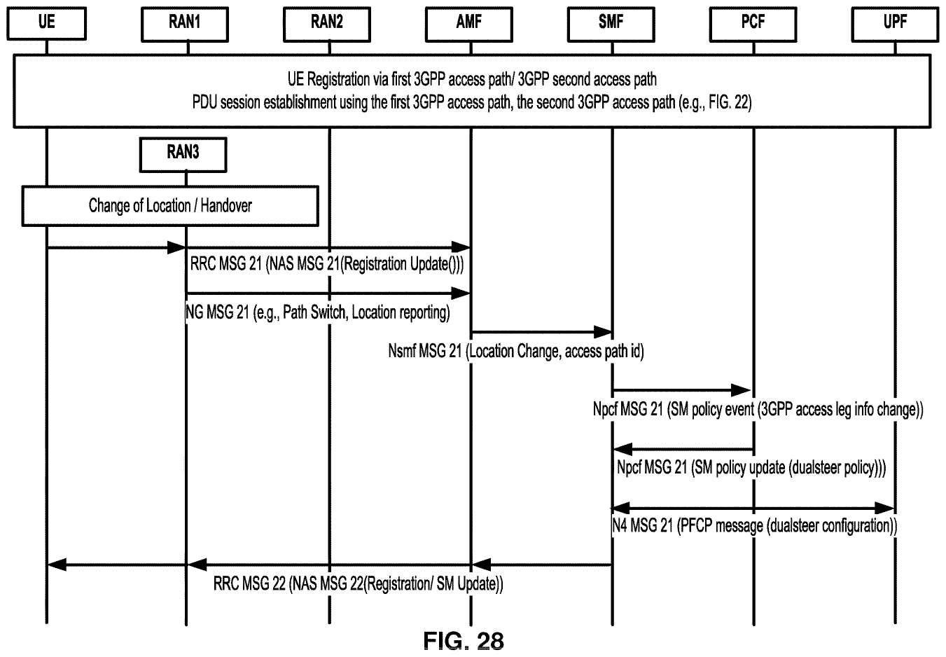

FIG. 28 depicts one example embodiment of the present disclosure. In an example, a UE may move from a first location (e.g., RAN 1) to a second location (RAN 3) for a first 3GPP access path. Based on location change of one or more 3GPP access paths, PCF may update a policy for a PDU session. For brevity, based on the other part of the present disclosure, redundant details will be omitted.

In an example, the UE may perform the first registration via the first RAN (e.g., RAN 1) and/or the second registration via the second RAN (e.g., RAN 2). The UE may be simultaneously registered via both the first 3GPP access path and the second 3GPP access path.

In an example, the UE may establish the PDU session. For the PDU session, the UE may add the first access path and/or the second access path to the PDU session. For this PDU session, the PCF may send a policy control request trigger (e.g., the first policy control request trigger, the second policy control request trigger) to the SMF. For example, the policy control request trigger may indicate that one or more location of the one or more 3GPP access paths change.

In an example, a location of the UE for the first access path may change. For example, due to radio condition change (e.g., 10 dBm to 5 dBm), the RAN 1 may determine to handover the UE to a RAN 3 (e.g., a third gNB, a third NG-RAN, and/or the like). In other example, the UE may perform a cell reselection from a first cell of the RAN 1 to a third cell of the RAN 3, based on the quality of the third cell is better than the first cell.

In an example, in response to the location change, the UE may send a NAS MSG 21 to the AMF 1 (or an AMF 3, if a new location is managed by the AMF 3 and/or if the new location is managed by a different network (e.g., PLMN, SNPN)) or the RAN 3 may send a NG MSG 21 to the AMF 1. For example, the NG MSG 21 may comprise at least one of the NAS MSG 21 and/or a UE location information 21. For example, the NG MSG 21 may be at least one of Path Switch message, location reporting message, UE initial message, UL transport message, and/or the like. For example, the NAS MSG 21 may be a registration update request 21. For example, the NAS MSG 21 may indicate at least one of the location change, the first access path, the identifier of the first access path, and/or that the location of the UE for the first access path changes to RAN 3 (e.g., the third cell, the third TA). For example, the UE location information 21 may indicate at least one of an identifier of the third cell, a tracking area of the third cell, and/or the like. In an example, the NG MSG 21 may be at least one of path switch request, Initial UE message, UL Transport, UE location reporting message, and/or the like.

In an example, the AMF 1 may receive the NG MSG 21. Because the NG MSG 21 (or via the NAS MSG 21) indicates at least one of the first access path, the UE location information 21, the change of location (e.g., change of area, area change) for the first access path, the AMF 1 may determine at least one of that the location of the UE for the first access path changes and/or that the location of UE for the first access path is the UE location information 21.

In an example, the AMF 1 may send to the SMF, a Nsmf MSG 21 to indicate the location change of the UE for the first 3GPP access path. For example, the Nsmf MSG 21 may comprise at least one of the UE location information 21, the NAS MSG 21, one or more information of the NAS MSG 21, the identifier of the first access path, and/or the like.

In an example, the SMF may receive the Nsmf MSG 21. Based on the information of the Nsmf MSG 21, the SMF may determine whether to update the SM policy session (association) with the PCF, and/or whether to contact the PCF. For example, because the Nsmf MSG 21 indicates change of the location of the UE for the first access path, the SMF may determine that the change of for dualsteer occurs. For example, when the SMF receives the Nsmf MSG 21, the SMF may determine whether one or more conditions indicated by the first/second policy control request trigger are met, and/or whether one or more events indicated by the first/second policy control request trigger occurs. For example, because the first/second policy control request trigger comprises the change for dualsteer, because the AMF indicates that the location for the first 3GPP access path changes, the SMF may determine that one or more events/condition of the first/second policy control request trigger is met, the SMF may determine to contact the PCF, and/or the SMF may determine to send a 21^{st} policy update request to report the met/triggered condition.

In an example, the SMF may send to the PCF, a Npcf MSG 21. In an example, in response to receiving the Npcf MSG 21, the PCF may send a Npcf MSG 22 to the SMF. For example, the Npcf MSG 22 may comprise updated policy information, considering new location of the first access path. In an example, the SMF may receive from the PCF, the Npcf MSG 21. The SMF may use information delivered by the Npcf MSG 21, to update configuration of one or more nodes (e.g., the UPF, the RAN 1, the RAN 2, the AMF 1).

The example of the FIG. 28 may assist a SMF to update configuration of one or more network node, in response to location change in one or more 3GPP access paths.

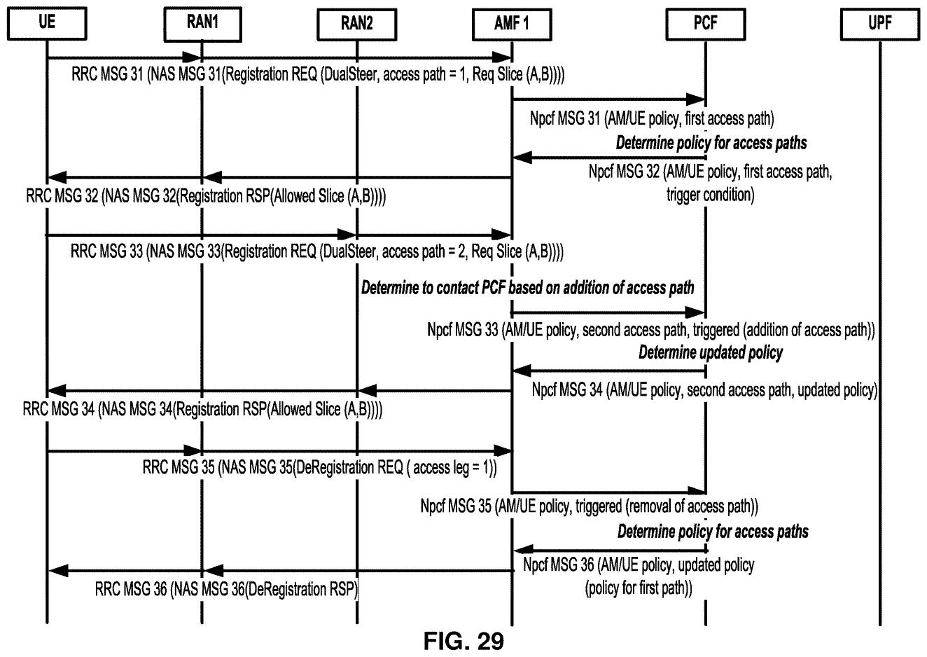

FIG. 29 depicts one example embodiment of the present disclosure. In an example, an AMF may receive an information of one or more policy triggers for dualsteer from a PCF. This may help the AMF to determine when to request a policy update for a UE registered for one or more 3GPP access paths. For brevity, based on the other part of the present disclosure, redundant details will be omitted.

In an example, the UE may perform a first registration via a first RAN (e.g., RAN 1). For the first registration, the UE may send a NSG MSG 31 via RRC MSG 31 (further via NG MSG 31) via the RAN 1, to the AMF 1 (of a first network (e.g., NPN, PLMN)). For example, the AMF 1 may be the AMF. The NAS MSG 31 may be at least one of a Registration Request message 31, UL NAS transport message 31 and/or the like. The NAS MSG 31 may comprise at least one an identifier of the UE, one or more requested network slices, a request for dualsteer registration (e.g., registration via one or more 3GPP access paths and/or one or more N3GPP access paths), a one or more capabilities of the UE, an indication of dualsteer, an indication (e.g., the registration is for the first 3GPP access path, an identifier of the first access path, and/or the like) of the first access path, and/or the like. The one or more capabilities of the UE may comprise a dualsteer capability indicator. For example, the NG MSG 31 may comprise the NAS MSG 31 and/or a UE location information 31. For example, the UE location information 31 may indicate the first cell ID of the first cell from which the UE access the network for the first 3GPP access path, and/or the first identifier of the first TA of the first cell. For example, the first cell ID and/or the first identifier of the first TA may be associated with the first access path of the 3GPP access type.

In an example, based on the information of the NG MSG 31, the AMF 1 may determine to establish an AM (and/or UE) policy session (association) with a PCF. For example, because the NAS MSG 31 comprises an indication that the UE requests a registration for the first access path, because the UE requests registration for dualsteer (or for multiple 3GPP access paths), the AMF 1 may determine to get the AM (and/or UE) policy from the PCF.

In an example, the AMF 1 may send to the PCF, a Npcf MSG 31 (e.g., 31^{st} Npcf message). For example, the Npcf MSG 31 may be at least one of 31^{st} Npcf_Policy_Authentication Create Request message, 31^{st} Npcf_AMPolicyControl Request message, 31^{st} Npcf_AMPolicyControl_Update Request message, 31^{st} Npcf_AMPolicyControl_UpdateNotify Request message, 31^{st} Npcf_UEPolicyControl Request message, 31^{st} Npcf_UEPolicyControl_Update Request message, 31^{st} Npcf_UEPolicyControl_UpdateNotify Request message, and/or the like. For example, the Npcf MSG 31 may comprise at least one of the identifier of the UE (e.g., SUPI), the one or more requested network slices, one or more allowed network slices for the UE (or for the first 3GPP access path), the UE location information 31, information of one or more registered access paths, the first RAT type of the first access path, the access type of the first access path, indication of support of the feature of dual steer by the UE, indication of request of dualsteer, indication of request of using a plurality of 3GPP access paths, indication of support of the feature of dualsteer by the AMF 1, indication of subscription of the UE for the use of the feature of the dualsteer, information (e.g., whether/what TN or NTN, whether/what PLMN or SNPN, backhaul type, capacity, frequency) of the first access path, serving network information (e.g., PLMN ID, SNPN ID) of the first access path, information of one or more first allowed network slices for the first access paths, information of one or more second allowed network slices for the second access paths, first location restriction information for the first access path and/or the like. For example, Npcf MSG 31 may comprise a feature tag. For example, the feature tag may indicate that the AMF 1 can support at least one of handing a policy control request trigger for the feature of dualsteer (e.g., receive/send/process/determine a policy for a plurality of 3GPP access path)

In an example, the PCF may receive the Npcf MSG 31. Because the Npcf MSG 31 indicates information associated with the dualsteer, the PCF may determine to construct an AM (or UE) policy information 32 for the UE and/or a police control request trigger 32. The AM (or UE) policy information 32 may comprise one or more information associated with the dualsteer. For example, the AM (or UE) policy information 32 may comprise at least one of a first service area restriction (e.g., allowed CN type, allowed TAs, allowed RAT types) for the first access path, a first URSP, a first AMBR (allowed/accumulated maximum bit rate) for the first access path, a first RFSP index for the first access path, and/or the like. For example, the policy control request trigger 32 may define one or more events that cause the AMF 1 (or other subsequent AMFs) to re-request of policy information (e.g., PCC rules) for the UE. For example, the policy control request trigger 32 may comprise at least one of a network (e.g., PLMN, NPN) change of the first access path, a location (area) change for the first access path, a change in access type of the first access path, a change for dualsteer, and/or the like. For example, the change for dualsteer may comprise at least one of an additional registration of an 3GPP access path for the UE, an additional registration of the second 3GPP access for the UE, a deregistration of a 3GPP access path for the UE, a deregistration of the first 3GPP access, a deregistration of the second 3GPP access, change (e.g., increase, decrease) in the number of registered 3GPP access paths for the UE, registration of the second 3GPP access after registration of the first 3GPP access to the PDU session, a change of location area (e.g., cell, RAN, TA, serving network) of one of the one or more 3GPP access paths registered for the UE, availability/unavailability change to one of the one or more 3GPP access paths registered for the UE, stopping use of the feature of the dualsteer, activation of the use of the feature of the dualsteer and/or the like. The policy control request trigger 32 may allow the AMF 1 to determine which events to monitor for dualsteer, when to contact the PCF again, when to report the events to the PCF, and/or the like. The policy control request trigger 32 may allow the PCF to determine which events to be notified, when to receive the information of the events from the AMF 1. For example, if the PCF does not support the feature of the dualsteer, the PCF may not send the first policy control request trigger associated with the dualsteer, to the AMF 1. For example, if the PCF support the feature of the dualsteer and/or if the PCF wants to update an AM (or UE) policy for the UE based on the events associated with the dualsteer, the PCF may send the policy control request trigger 32 associated with the dualsteer, to the AMF 1.

In an example, in response to receiving the Npcf MSG 31, the PCF may send a Npcf MSG 32 to the AMF 1. For example, the Npcf MSG 32 may be at least one of a second Npcf_Policy_Authentication Create Response 32 message, a Npcf_AMPolicyControl Response message 32, a second Npcf_AMPolicyControl_Update Response message 32, a second Npcf_AMPolicyControl_UpdateNotify Response message 32, a Npcf_UEPolicyControl Response message 32, a second Npcf_UEPolicyControl_Update Response message 32, a second Npcf_UEPolicyControl_UpdateNotify Response message 32, and/or the like. For example, the Npcf MSG 32 may comprise at least one of an AM (or UE) policy Association ID, the AM policy information 32, and/or the policy control request trigger 32.

In an example, the AMF 1 may receive from the PCF, the Npcf MSG 32. The AMF 1 may use the information delivered by the Npcf MSG 32, to configure one or more nodes (e.g., the RAN 1, the UE). For example, because the policy control request trigger indicates the change for dualsteer, the AMF 1 may send to the RAN 1 (or the RAN 2, the UE), a request to notify the AMF 1 if there is the change for dualsteer. For example, where there is the change for dualsteer, the RAN 1 (or the RAN 2, the UE) may send a message to the AMF 1 to report the change.

In an example, in response to receiving the NAS MSG 31, the AMF 1 may send to the UE, a NAS MSG 32. For example, the NAS MSG 32 may indicate successful registration of the UE for the first 3GPP access path and/or may indicate one or more allowed network slices for the first access path.

In an example, after registering via the first access path, the UE may determine to additionally register via the second access path. For example, the UE may perform a second registration via a second RAN (e.g., RAN 2). For the second registration, the UE may send a NSG MSG 33 via RRC MSG 33 (further via NG MSG 33) via the RAN 2 to the AMF 2. In an example, the AMF 2 may be the AMF 1 or the AMF. In other example, the AMF 1 and the AMF 2 may belong to different networks (e.g., different PLMNs, different SNPNs). The NAS MSG 33 may be at least one of a Registration Request message 33, UL NAS transport message 33 and/or the like. The NAS MSG 33 may comprise at least one the identifier of the UE, the one or more requested network slices, the request for dualsteer registration, the indication of dualsteer, an indication (e.g., the registration is for the second 3GPP access path, an identifier of the second access path, and/or the like) of the second access path, and/or the like. For example, the NG MSG 33 may comprise the NAS MSG 33 and/or a UE location information 33. For example, the UE location information 33 may indicate the second cell ID of the second cell from which the UE access the network for the second 3GPP access path, and/or the second identifier of the second TA of the second cell. For example, the second cell ID and/or the second identifier of the second TA may be associated with the second access path of the 3GPP access type.

In an example, the AMF 2 may receive the NAS MSG 33 and/or the NG MSG 33. Based on the information in the NG MSG 33, the AMF 2 may determine whether to update the AM (or the UE) policy session (association) with the PCF, and/or whether to contact the PCF. For example, because the NG MSG 33 comprises the indication that the UE requests registration of the second 3GPP access path, because the UE requests additional 3GPP access path registration in addition to the registered 3GPP access path (e.g., the first 3GPP access path), because the UE requests registration of one or more 3GPP access paths, because the UE requests additional registration of the 3GPP access path, the AMF 2 may determine that the change of for dualsteer occurs. For example, when the AMF 2 receives the NG MSG 33, the AMF 2 may determine whether one or more conditions indicated by the policy control request trigger 31 are met, and/or whether one or more events indicated by the policy control request trigger 31 occurs. For example, because the policy control request trigger 31 comprises the change for dualsteer, because the UE is requesting additional registration for the 3GPP access path (e.g., the second access path), because the change for dualsteer comprises an event (e.g., additional registration of 3GPP access paths, e.g., registration of the second access path), the AMF 2 may determine that one or more events/condition of the policy control request trigger 31 is met, the AMF 2 may determine to contact the PCF, and/or the AMF 2 may determine to send a policy update request to report the met/triggered condition (or the event).

In an example, the AMF 2 may send to the PCF, a Npcf MSG 33. For example, the Npcf MSG 33 may be at least one of Npcf_Policy_Authentication Create Request message 33, Npcf_AMPolicyControl Request message 33, Npcf_AMPolicyControl_Update Request message 33, Npcf_AMPolicyControl_UpdateNotify Request message 33, Npcf_UEPolicyControl Request message 33, Npcf_UEPolicyControl_Update Request message 33, Npcf_UEPolicyControl_UpdateNotify Request message 33, and/or the like. For example, the Npcf message may comprise at least one of the AM (or UE) policy Association ID, the identifier of the UE (e.g., SUPI), the second RAT type of the second access path, one or more RAT types of the one or more 3GPP access paths, the access type of the second access path, indication of support of the feature of dual steer by the UE, indication of support of the feature of dualsteer by the AMF 2, indication of support of the feature of dualsteer by the AMF 2, indication of subscription of the UE for the use of the feature of the dualsteer, indication that the second 3GPP access path is requested to be additionally registered, indication that the dualsteer PDU session is requested, the UE location information 33, information (e.g., the second access path is registered) of the policy control request trigger condition that has been met, information of one or more 3GPP access paths registered/requested, and/or the like. For example, the information on the policy control request trigger condition that has been met may indicate that the second 3GPP access is registered (requested) for the UE, that the second access path is requested to be registered for the UE, the change for dualsteer, addition of 3GPP access, addition of the second 3GPP access, increase (or decrease) in the n umber of 3GPP access paths for UE, and/or the like.

In an example, the PCF may receive the Npcf MSG 33. Because the Npcf MSG 33 indicates information associated with the dualsteer, the PCF may determine to construct an AM (or UE) policy information 34 for the UE and/or a police control request trigger 34. The AM (or UE) policy information 34 may comprise one or more information associated with the dualsteer. For example, the AM (or UE) policy information 34 may comprise at least one of a second service area restriction (e.g., allowed CN type, allowed TAs, allowed RAT types) for the second access path, a second URSP, a second AMBR (allowed/accumulated maximum bit rate) for the second access path, a second RFSP index for the second access path, and/or the like. For example, the policy control request trigger 34 may define one or more events that cause re-request of policy information (e.g., PCC rules) for the UE. For example, the policy control request trigger 34 may comprise at least one of a network change of the second access path, a location (or area) change for the second access path, a change in access type of the second access path, a change for dualsteer, and/or the like.

In an example, in response to receiving the Npcf MSG 33, the PCF may send a Npcf MSG 34 to the AMF 1. For example, the Npcf MSG 34 may be at least one of a second Npcf_Policy_Authentication Create Response 34 message, a Npcf_AMPolicyControl Response message 34, a second Npcf_AMPolicyControl_Update Response message 34, a second Npcf_AMPolicyControl_UpdateNotify Response message 34, a Npcf_UEPolicyControl Response message 32, a second Npcf_UEPolicyControl_Update Response message 34, a second Npcf_UEPolicyControl_UpdateNotify Response message 34, and/or the like. For example, the Npcf MSG 34 may comprise at least one of the AM (or UE) policy Association ID, the AM policy information 34, and/or the policy control request trigger 34.

In an example, the UE may determine to de-register the second 3GPP access path from a plurality of registered 3GPP access paths. In this case, a similar procedure described above can be employed. For example, in the FIG. 29, a RRC MSG 35 (or NAS MSG 35) may be similar to the RRC MSG 33 (or NAS MSG 33), but may indicate deregistration of the second access path. For example, a Npcf MSG 35 may be similar to the Npcf MSG 33, but may indicate deregistration of the second access path. Based on the NAS MSG 35, the AMF 2 (or the AMF 1) may determine that there is a change in the use of plurality of 3GPP access paths /sed/ /lowed/ configured) for the UE, may determine that an event indicated by the condition is met, and/or may send notification to the PCF that the event (or the condition) associated with the plurality of 3GPP access paths is met/triggered.

The example of FIG. 29 may assist for an AMF to determine when to request an updated UE (or AM) policy for the UE.

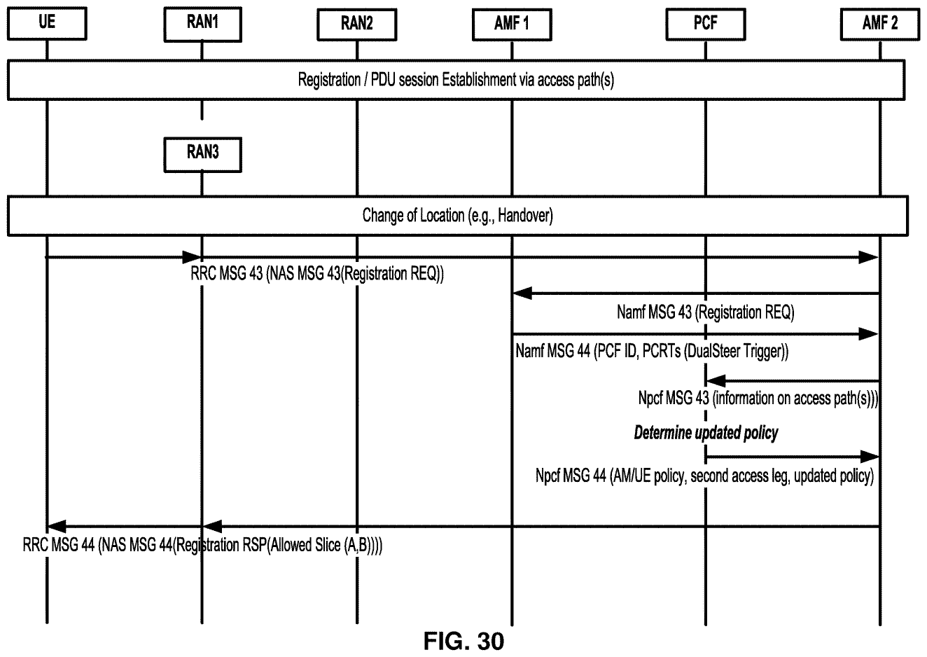

FIG. 30 depicts one example embodiment of the present disclosure. In an example, when a UE is handed over, a source AMF indicates to a target AMF, information of when to contact a PCF for a change associated with dualsteer. This may help the target AMF when to update a policy for the UE. For brevity, based on the other part of the present disclosure, redundant details will be omitted.

In an example, the UE may register via the first access path and/or the second access path, and/or establish the PDU session. For example, the example of FIG. 22 may be used. For example, the AMF 1 may receive from the PCF, the policy control request trigger comprising the change of the dualsteer.

In an example, the location of the UE may change. In response to the change of the location, the UE may send a NAS MSG 43, or the RAN 3 may send a NG MSG 43, to the AMF 2 (e.g., the RAN 3 is connected to the AMF 2, e.g., the RAN 3 is associated with the first access path). For example, similar to FIG. 28, the NAS MSG 43 may be similar to the NAS MSG 21 and/or the NG MSG 43 may be similar to NG MSG 21. For example, the NAS MSG 43 and/or the NG MSG 43 may comprise the identifier of the UE (or the identifier of the UE for the first access path). For example, the identifier of the UE may indicate the AMF 1 holding a context of the UE for the first access path.

In an example, reverting back to FIG. 30, the AMF 2 may receive the NAS MSG 43 and/or the NG MSG 43 for the first access path. For example, because the AMF 2 does not have the context of the UE and/or because the identifier of the UE indicates the AMF 1, the AMF 2 may determine to request from the AMF 1, the context of the UE. For example, the AMF 2 may send to the AMF 1, the Namf_UEContextTransfer request message. For example, the Namf_UEContextTransfer request message may indicate at least one of the identifier of the UE, the NAS MSG 43, the identifier of the first access path, an indication indicating whether the AMF 2 supports the feature of the dualsteer, and/or the like.

In an example, the AMF 1 may receive the Namf_UEContextTransfer request message. In response to receiving the Namf_UEContextTransfer request message, because the AMF 2 supports the feature of the dualsteer, the AMF 1 may determine to transfer to the AMF 2, the context of the UE. For example, the context of the UE may comprise at least one of, the one or more allowed network slices, information of the one or more 3GPP access paths registered for the UE, the policy control request trigger (e.g., one or more trigger associated with the change of the dualsteer), an identifier of the PCF, information (e.g., PDU session ID, whether the PDU session is established for the dualsteer) of one or more PDU sessions of the UE, and/or the like. In other example, if the AMF 2 does not support the feature of the dualsteer, the AMF 1 may not send e.g., the information of the one or more 3GPP access paths registered for the UE, the one or more trigger associated with the change of the dualsteer, and/or the identifier of the PCF.

In an example, the AMF 2 may receive from the AMF 1, the context of the UE. After receiving the policy control request trigger of the context, the AMF 2 may determine whether one or more condition of the policy control request trigger is met for the UE. For example, because the policy control request trigger comprises the change for dualsteer, because the cell (or TA, AMF) for the first access path changes, the AMF 2 may determine to contact the PCF and/or the AMF 2 may determine to notify the policy trigger which is met. For example, the AMF 2 may send to the PCF, Npcf MSG 43. For example, the Npcf MSG 43 may indicate that there is a change in first 3GPP access path among the one or more 3GPP access paths for the UE. For example, based on the Npcf MSG 43, the PCF may determine to update a policy (e.g., UE policy, AM policy) for the UE (or for the first access path). For example, the PCF may send a Npcf MSG 44 to deliver to the AMF 2, the updated policy.

The example of FIG. 30 may assist a network to update a policy for the UE when there is a change of AMF for one of the one or more 3GPP access paths.

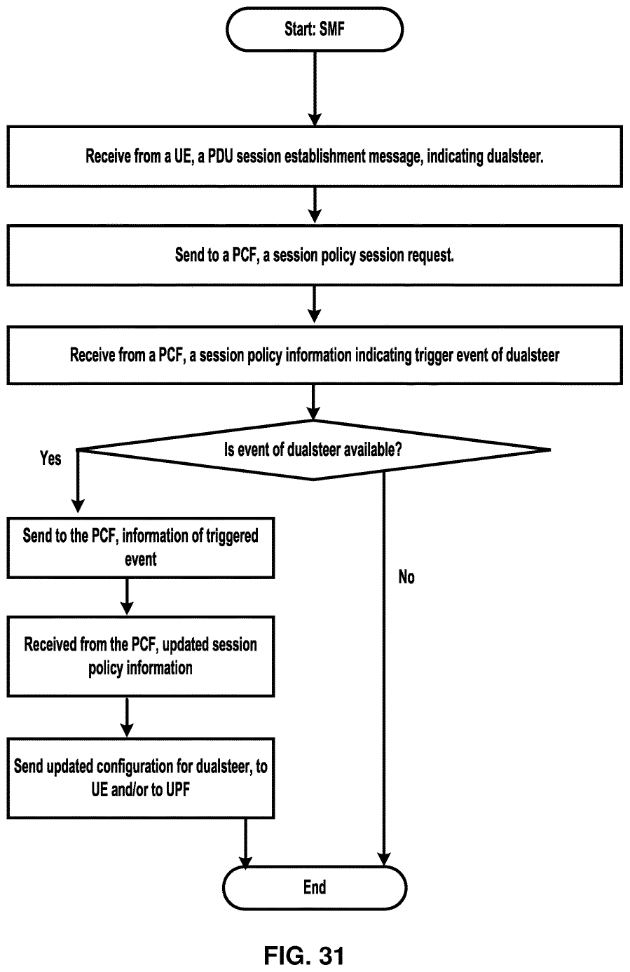

FIG. 31 depicts one example embodiment of the present disclosure.

In an example, a SMF may receive from a UE, a PDU session establishment request message for a PDU session. For example, the PDU session establishment request may indicate that the PDU session is for dualsteer. For example, that the PDU session is for dualsteer may be that the PDU session is to use one or more 3GPP access paths. In an example, the SMF may send to a PCF, a SM Policy session establishment request. For example, the SM policy session establishment request may indicate that the UE supports the feature of the dualsteer, that the UE requests the PDU session to be allowed to use one or more 3GPP access paths. In an example, the SMF may receive from the PCF, a SM policy information (e.g., a PCC (policy and charging control) rule for the PDU session). For example, the PCC rule may indicate one or more QoS parameters for the PDU session, and/or one or more policy control request triggers. For example, the one or more policy control request triggers may indicate the change for the dualsteer (e.g., addition of additional 3GPP access paths, removal of a 3GPP access paths from a plurality of 3GPP access paths, area change of a 3GPP access path, etc.). In an example, the SMF may determine whether an event matching the one or more policy control request triggers is met. For example, if additional (e.g., adding a second 3GPP access path to the PDU session using a first 3GPP access path) 3GPP access path is added to the PDU session, the SMF may determine that a condition (e.g., a event) of the one or more policy control request triggers is met and/or the SMF may send to the PCF a notification that a policy control request trigger is met. In an example, the SMF may receive an updated SM policy information from the PCF. For example, the SMF may send an updated configuration (e.g., increased/decreased peak data rate, supported packet error rate, supported packet delay budget, and/or the like) for the PDU session to one or more nodes (e.g., the UE, a UPF, a NG-RAN).

In an example, a session management function (SMF) may receive from a policy control function (PCF), a policy control message comprising a condition (e.g., one or more events) for triggering a policy control request, wherein the condition indicates a change in a number of 3GPP access paths (setup, used, configured, allowed, requested) for a protocol data unit (PDU) session of a wireless device. In an example, the SMF may receive from an access and mobility management function (AMF), a session management message (e.g., a SM message from a UE, Nsmf (Namf) message from the AMF) indicating the change (e.g., indicating the number of 3GPP access paths increasing/decreasing). In an example, the SMF may determine, based on the session management message, that the condition (e.g., the one or more events) is met. In an example, the SMF may send to the PCF, the policy control request indicating that the condition is met and/or the information of the one or more events (triggers) associated with the dualsteer.

In an example, an access and mobility management function (AMF) may receive from a policy control function (PCF), a policy control message comprising a condition for triggering a policy control request, wherein the condition indicates a change in a number of 3GPP access paths registered for the wireless device. In an example, the AMF may receive from the wireless device, a non-access stratum (NAS) message indicating the change. In an example, the AMF may determine, based on the NAS message, that the condition is met. In an example, the AMF may send to the PCF, the policy control request indicating that the condition is met.

In an example, a core network node may receive from a policy control function (PCF), a policy control message comprising a condition for triggering a policy control request, wherein the condition indicates a change (e.g., one or more events/triggers) associated with a plurality of 3GPP access path of the wireless device and/or a change (e.g., increase of the number of 3GPP access paths from 1 to more than 1) associated with one or more 3GPP access paths. For example, the change may be a change (e.g., from 1 to 2, from 2 to 1, and/or the like) in a number of 3GPP access path.

In an example, the core network node may send to the PCF, the policy control request indicating that the condition (e.g., an event occurs) is met and/or indicating a change in the number of 3GPP access path of a wireless device (e.g., a UE).

In an example, the core network node may be a session management function (SMF). In an example, the SMF may receive from a first access and mobility management function (AMF), a session management message (e.g., Nsmf messages, Namf messages) comprising information of the plurality of 3GPP access path. For example, the information of the plurality of 3GPP access path may indicate at least one of the change (e.g., registered, allowed, available, used and/or the like) in the number of 3GPP access path (for the PDU session, for the UE), the change associated with a 3GPP access path among the plurality of 3GPP access path, an identity (identifies) of a 3GPP access path (paths) associated with the change, and/or the like. For example, the change associated with the plurality of 3GPP access path may comprise at least one of
addition of a first 3GPP access path to the plurality of 3GPP access path (e.g., when/while the first 3GPP access path and the second 3GPP access path are configured)
a removal of the first 3GPP access path from the plurality of 3GPP access path (e.g., when/while the first 3GPP access path and the second 3GPP access path are configured)
a change of RAT for the first access path, unavailability of the first 3GPP access path when (while) the first 3GPP access path and the second 3GPP access path are configured
a change of area (e.g., a cell, a tracking area, a RAT type, and/or the like) of the first access path when (while)the first 3GPP access path and the second 3GPP access path are configured
availability of the first 3GPP access path when (while) the first 3GPP access path and the second 3GPP access path are configured
addition of the second 3GPP access path when (while) the first 3GPP access path is configured
removal of the second 3GPP access path when (while) the first 3GPP access path and the second 3GPP access path are configured
a change of RAT for the first access path, change of characteristic (e.g., backhaul type change, capacity change, data-rate change, QoS change, etc.) of the first access path when the first 3GPP access path and the second 3GPP access path are configured, and/or the like.

For example, each of the plurality of the 3GPP access path may use a radio access technology (RAT) of 3GPP. For example, the RAT of 3GPP may be at least one of E-UTRA, NR, 3 6G radio technology, and/or the like. For example, the each of the plurality of 3GPP access path may use at least one of a gNB, an eNB, a ng-eNB, an en-gNB, and/or a 6G radio access node. In an example, the plurality of 3GPP access path may be used for a protocol data unit (PDU) session.

In an example, the SMF may determine whether the condition is met. For example, the SMF may use the session management message received from the first AMF. For example, the AMF may receive from a base station (associated with at least one of the plurality of the 3GPP access paths) and/or from the wireless device, an information message. For example, the information message may indicate at least one of a request to add an 3GPP access path, a request to register a 3GPP access path, a first notification indicating the change of the area, a second notification indicating the change of the characteristic, a third notification indicating availability of the at least one of the 3GPP access path, a fourth indication indicating unavailability of the at least one of the 3GPP access path, and/or the like. For example, based on the information message, the AMF may determine whether there is a change of the plurality of 3GPP access paths and/or may send the session management message to the SMF. For example, the session management message may indicate one or more information indicated by the information message. For example, if information delivered by the session management message meets the condition (e.g., at least one event/trigger) indicated by the policy control message, the SMF may determine that the condition is met.

In an example, the SMF may send to the PCF, a (second) policy control request. For example, because the SMF determines that the condition is met, the SMF may send the (second) policy control request. For example, the (second) policy control request may indicate that the condition is met and/or that a triggering condition (e.g., the event occurs) is met. For example, the (second) policy control request may further comprise one or more identifiers of one or more 3GPP access paths of the plurality of 3GPP access path. In an example, the SMF may send to the PCF, a (first) policy control request. In an example, in response to sending the (first) policy control request, the SMF may receive the policy control message.

In an example, the SMF may receive from at least one of at least one of a bootstrapping function (BSF), a unified data repository (UDR) or a unified data management (UDM), an address information of the PCF. For example, the SMF may use the address information to communicate with the PCF.

In an example, the core network node is an access and mobility management function (AMF). In an example, the AMF may receive the policy control message from the PCF and/or the AMF may receive information of the policy control message from the second AMF. In an example, the policy control message comprises a policy information for the first access path, and the identifier of the first access path, a policy information for the UE, a policy information for the second access path (or a plurality of 3GPP access paths), and/or the identifiers of the plurality of 3GPP access paths, the condition. For example, the AMF may send to the PCF, a first wireless device location information of the first access path and a second wireless device location information of the second access path, via the policy control request.

In other example, the AMF may receive from a second AMF, a context information of the UE, wherein the context information comprises the condition and/or the address of the PCF. For example, the second AMF may send the context information to the AMF, when the UE change location or when the UE hands over. In an example, the AMF may receive the context information, after sending a request for the context information, wherein the wireless device is handover from the second AMF to the AMF. In an example, the PCF for the AMF may be different from the PCF for the SMF. For example, the context information may comprise one or more information of the policy control message.

In an example, the AMF may receive from the wireless device, a non-access stratum (NAS) message indicating registration change (e.g., registration request adding/remove one or more 3GPP access paths, indication of availability/unavailability of one or more 3GPP access path) for at least one of the plurality of 3GPP access paths. For example, the registration change may be at least one of registration of the first access path for the plurality of 3GPP access path (e.g., at least one 3GPP access path), de-registration of the first access path from the plurality of 3GPP access path (e.g., more than one 3GPP access paths), change of tracking area of the first access path, change of network slices (e.g., allowed, registered) for the first access path, change of the RAT of the first access path, unavailability of the first 3GPP access path, a change of area (e.g., cell, TA, gNB) of the first access path, or availability of the first 3GPP access path.

In an example, the AMF may send to the PCF, the policy control request, based on that the condition is met. For example, the AMF may determine whether the condition (e.g., one or more events indicated by the condition) of the policy control message is indicated by the registration change. For example, the AMF may receive from the UE and/or the base station, the information message. For example, based on the information message, the AMF may receive the information of the registration change and/or may determine the registration change.

In an example, the policy control request may comprise one or more identities of one or more access paths (e.g., associated with change) of the plurality of 3GPP access path.

In an example, in response to sending the policy control request, the AMF may receive from the PCF, a second policy control message, wherein the second policy control message comprises at least one of updated network slices policy (e.g., allowed network slices, considering change in the one or more 3GPP access paths), updated mobility restriction information (e.g., for each 3GPP access path, considering change in the one or more 3GPP access paths), updated RFSP (e.g., for each 3GPP access path, considering change in the one or more 3GPP access paths), and/or the like. For example, the AMF may receive from the PCF, the second policy control message in response to sending the policy control request. In an example, the AMF may receive from the PCF, a first mobility restriction information (e.g., first allowed networks, first allowed frequency, first allowed RATs, first allowed service area, and/or the like) for the first access path and a second mobility restriction information (e.g., second allowed networks, second allowed frequency, second allowed RATs, second allowed service area, and/or the like) for the second access path, via the second policy control message and/or via the policy control message.

In an example, session management function (SMF) may receive from a policy control function (PCF), a policy control message comprising a condition for triggering a policy control request, wherein the condition indicates a change of 3GPP access paths for a protocol data unit (PDU) session of a wireless device. For example, the change of 3GPP access paths may be at least one of a first change in the first access path (if the second access path and the first access path configured), a second change in the second access path (if the second access path and the first access path configured), addition of the second access path (e.g., except the first 3GPP access path, the wireless device is not configured with other 3GPP access path), a removal of the second (or the first) access path (if the second access path and the first access path configured), and/or the like. In an example, the SMF may send to an access and mobility management function (AMF), a request for reporting the change of the 3GPP access paths. In an example, the SMF may receive from the AMF, a report indicating the change in at least one 3GPP access path of the 3GPP access paths. In an example, the SMF may send to the PCF, the policy control request indicating that the condition is met

In an example, a session management function (SMF) may receive from a policy control function (PCF), a policy control message comprising a condition for triggering a policy control request, wherein the condition indicates a change of 3GPP access paths for a protocol data unit (PDU) session of a wireless device. In an example, the SMF may send to a user plane function (UPF), a request for reporting a change in at least one 3GPP access path of the 3GPP access paths. In an example, the SMF may receive from the UPF, a report indicating the change in at least one 3GPP access path. In an example, the SMF may send to the PCF, the policy control request indicating that the condition is met.

In an example, a wireless device (e.g., UE) may receive from a session management function (SMF), a message indicating to report a change of 3GPP access paths for a protocol data unit (PDU) session. In an example, the wireless device may send to a user plane function (UPF), a report message indicating a status of at least one 3GPP access path of the 3GPP access paths, wherein the status indicates at least one of availability or unavailability of the at least one 3GPP access path.

In an example, a session management function may send to a wireless device, a protocol data unit (PDU) session establishment accept message, wherein the PDU session is configured with a first 3GPP access path and a N3GPP access path. In an example, the SMF may receive from the wireless device, a PDU session modification request message, wherein the PDU session modification request message requests addition of a second 3GPP access path to the PDU session. In an example, the SMF may send to a policy control function, a policy control request trigger indicating the second 3GPP access path.

In an example, a first access and mobility control function (AMF) may send to a second (AMF), a context request message for a wireless device. In an example, the first AMF may receive from the second AMF, a context response message, wherein the context response message comprise at least one of:
information of one or more 3GPP access paths for the wireless device;
a condition for triggering a policy control request, wherein the condition comprises one or more events associated with using the one or more 3GPP access path;

In an example, the first AMF may determine that at least one event of the one or more events occurs. In an example, the first AMF may send to a policy control function, the policy control request indicating the at least one event.

In some aspects, the techniques described herein relate to a method including: receiving, by a session management function (SMF) from a dualsteer wireless device, one or more first protocol data unit (PDU) session establishment requests for the dualsteer, wherein, in the dualsteer, the wireless device communicates with a network via a plurality of 3GPP access paths; receiving, by the SMF, one or more report messages indicating that an event, of one or more events, occurs, wherein: the event is that at least one 3GPP access path, of the plurality of 3GPP access paths, becomes unavailable; and the one or more messages includes an identifier indicating the event and an identifier associated with the at least one 3GPP access path; receiving, by the SMF (from PCF), one or more updated policy information for the dualsteer wireless device; and sending, by the SMF to the dual wireless device and based on the one or more updated policy information, one or more PDU session modification messages including one or more parameters for one or more PDU sessions.

In some aspects, the techniques described herein relate to a method including: sending, by a wireless device supporting dualsteer, one or more first protocol data unit (PDU) session establishment requests for the dualsteer, wherein, in the dualsteer, the wireless device communicates with a network via a plurality of 3rd generation partnership project (3GPP) access paths; determining, by the wireless device, whether an event, of one or more events, occurs, wherein the event is that at least one 3GPP access path, of the plurality of 3GPP access paths, becomes unavailable; sending, by the wireless device, one or more report messages indicating: an identifier indicating the event; and an identifier associated with the at least one 3GPP access path; and receiving, by the wireless device, one or more PDU session modification messages.

In some aspects, the techniques described herein relate to a method including: sending, by a wireless device supporting dualsteer, one or more messages indicating whether at least one 3rd generation partnership project (3GPP) access path, of a plurality of 3GPP access paths registered for the wireless device, is unavailable.

In some aspects, the techniques described herein relate to a method, further including, receiving by the wireless device, one or more protocol data unit (PDU) session messages including at least one of an updated policy control information or one or more parameters for the one or more PDU sessions for the dualsteer, in response to sending the one or more messages.

In some aspects, the techniques described herein relate to a method, wherein the wireless device sends the one or more messages to at least one of a policy control node, a session management function (SMF), an access and mobility management function (AMF), a user plane function (UPF), a performance management function (PMF).

In some aspects, the techniques described herein relate to a method, wherein the wireless device sends the one or more messages, based on receiving a configuration message configuring the wireless device to send the one or more messages.

In some aspects, the techniques described herein relate to a method, wherein the configuration message indicates an event, of one or more events, that the at least one 3GPP access paths becomes available or unavailable.

In some aspects, the techniques described herein relate to a method, wherein the one or more messages includes at least one of an identifier of the event that is met, an identifier associated with the at least one 3GPP access path and an indication indicating 3GPP access type.

In some aspects, the techniques described herein relate to a method, wherein the one or more messages are performance measurement function protocol message sent to a performance measurement function.

In some aspects, the techniques described herein relate to a method, wherein each of the plurality of 3GPP access path uses at least one of a gNB, an eNB, a ng-eNB or an en-gNB and each of the plurality of 3GPP access path uses a radio access technology (RAT) of at least one of a E-UTRA, a NR, 3GPP RAT or a 6G radio technology.

In some aspects, the techniques described herein relate to a method, wherein the wireless device receives the configuration message, after sending one or more request messages indicating at least one of that the wireless device supports a capability of the dualsteer; that the wireless device requests one or more PDU sessions associated with the dualsteer; one or more identifiers of the one or more PDU sessions associated with the dualsteer; one or more identifiers associated with the plurality of 3GPP access paths.

In some aspects, the techniques described herein relate to a method, wherein, in the dualsteer, the wireless device communicates one or more data packets via the plurality of 3GPP access paths, or the wireless devices is concurrently registered via the plurality of 3GPP access paths.

In some aspects, the techniques described herein relate to a method, wherein the wireless device activates a first resources associated with a first 3GPP access path of the plurality of 3GPP access paths, and release a second resources associated with a second 3GPP access path of the plurality of 3GPP access paths, based on that the at least one 3GPP access path is the second 3GPP access path.

In some aspects, the techniques described herein relate to a method, wherein the wireless device receives from a SMF, one or more PDU session modification messages including one or more parameters for one or more PDU sessions for dualsteer.

In some aspects, the techniques described herein relate to a method including: sending, by a wireless device supporting dualsteer, one or more protocol data unit (PDU) session establishment requests, wherein, in the dualsteer, the wireless device registers a plurality of 3rd generation partnership project (3GPP) access paths; determining, by the wireless device, whether an event, of one or more events, occurs, wherein the event is that a second 3GPP access path of the plurality of 3GPP access paths is released; and sending, by the wireless device, a message requesting activation of a PDU session associated with a first 3GPP access path of the plurality of 3GPP access paths.

In some aspects, the techniques described herein relate to a method including: sending, by a wireless device supporting dualsteer, one or more protocol data unit (PDU) session establishment requests, wherein, in the dualsteer, the wireless device registers a plurality of 3rd generation partnership project (3GPP) access paths; determining, by the wireless device, whether an event, of one or more events, occurs, wherein the event is that a second 3GPP access path of the plurality of 3GPP access paths is de-registered; and releasing, by the wireless device, a resource associated with the second 3GPP access path.

In some aspects, the techniques described herein relate to a method including: receiving, by a wireless device from a session management function (SMF), a message indicating to report a change of a 3rd generation partnership project (3GPP) access path for a data session, wherein the data session is established via a plurality of 3GPP access paths; and sending, by the wireless device to a user plane function (UPF), a report message indicating a status of at least one of the plurality of 3GPP access paths, wherein the status indicates at least one of availability or unavailability of the at least one of the plurality of 3GPP access path.

In some aspects, the techniques described herein relate to a method, further including, sending by the wireless device to the SMF, a PDU session establishment request for the data session, including an indication that the wireless device supports the dualsteer.

In some aspects, the techniques described herein relate to a method, wherein the change of the 3GPP access path is that at least one of the plurality of 3GPP access paths becomes unavailable.

In some aspects, the techniques described herein relate to a method, wherein the wireless sends the report message, based on that the at least one of the plurality of 3GPP access paths becomes unavailable.

In some aspects, the techniques described herein relate to a method, further including sending by the wireless device, a second report message indicating that a second 3GPP access path of the plurality of 3GPP access paths becomes available and an identifier of the second 3GPP access path.

In some aspects, the techniques described herein relate to a method, wherein the wireless device is registered for the plurality of 3GPP access paths.

In some aspects, the techniques described herein relate to a method, wherein the report message is a performance measurement function (PMF) message.

In some aspects, the techniques described herein relate to a method including: sending, by a first core network node to a second core network node, one or more message indicating that the first core network node supports dualsteer, wherein: in the dualsteer, a wireless device communicates with a network via a plurality of 3rd generation partnership project (3GPP) access path; and a 3GPP access path is a 3GPP access type, of a plurality access types including the 3GPP access type and a non- 3GPP access type.

In some aspects, the techniques described herein relate to a method including: sending, by a session management node to a wireless device, one or more session management messages for dualsteer, wherein, in the dualsteer, a wireless device is registered via a plurality of 3rd generation partnership project (3GPP) access paths; receiving, by the session management node from a mobility manage node, an indication indicating that a first 3GPP access path, of the plurality of 3GPP access paths, is released; and releasing, by the session management node, a resource associated with the first 3GPP access path, among one or more resources allocated for the plurality of 3GPP access paths.

In some aspects, the techniques described herein relate to a method including: receiving, by a session management function (SMF) from a policy control function (PCF), a policy control session message including a condition for triggering a policy control request, wherein the condition indicates a change in at least one 3GPP access path of a plurality of 3GPP access paths for a wireless device; receiving, by the SMF from an access and mobility management function (AMF), a message indicating release of resource associated with a first 3GPP access path of the plurality of 3GPP access paths; and sending, by the SMF to the PCF and based on the message, the policy control request.

What is claimed is:

1. A core network node comprising:
one or more processors; and
memory storing instructions that, when executed by the one or more processors, cause the core network node to:
receive, from a policy control node, one or more policy session messages comprising one or more conditions for triggering a first policy session message, wherein a condition of the one or more conditions comprises that at least one 3rd generation partnership project (3GPP) access path, of a plurality of 3GPP access paths, changes; and
based on the receiving, send, to the policy control node, the first policy session message indicating a 3GPP access path, of the plurality of 3GPP access paths for a wireless device supporting dualsteer.

2. The core network node of claim 1, wherein the sending the first policy session message is further based on receiving, from a mobility management node, one or more messages indicating at least one of:
information of the plurality of 3GPP access paths;
information of a second 3GPP access path, of the plurality of 3GPP access paths;
information indicating that the mobility management node supports dualsteer;
information indicating that the wireless device supports dualsteer;
information indicating that the wireless device requests a resource for the dualsteer;
request for a protocol data unit (PDU) session via the second 3GPP access path;
a first 3GPP access path identifier associated with a first 3GPP access path, of the plurality of 3GPP access paths, for the wireless device; or
a second 3GPP access path identifier associated with the second 3GPP access path.

3. The core network node of claim 2, wherein the information of the plurality of 3GPP access paths indicates at least one of:
addition of the second 3GPP access path;
removal of the first 3GPP access path; or
the second 3GPP access path identifier.

4. The core network node of claim 1, wherein the sending the first policy session message is further based on determining that the condition is met.

5. The core network node of claim 2, wherein that the at least one 3GPP access path changes comprises at least one of:
that a number of the plurality of 3GPP access paths for the wireless device increases;
that the number of the plurality of 3GPP access paths for the wireless device decreases;
that the second 3GPP access path is added to the plurality of 3GPP access path;
that the first 3GPP access path is removed from the plurality of 3GPP access path;
that at least one 3GPP access path of the plurality of 3GPP access paths becomes unavailable;
that at least one 3GPP access path of the plurality of 3GPP access paths becomes available;
that a radio access technology (RAT) type of the at least one 3GPP access path changes;
that a location of the at least one 3GPP access path changes; or
that a network associated with the at least one 3GPP access path changes.

6. The core network node of claim 2, wherein the instructions further cause the core network node to determine to send the first policy session message, based on the one or more messages and the one or more policy session messages.

7. The core network node of claim 1, wherein:
each of the plurality of 3GPP access paths uses at least one of a gNB, an eNB, a ng-eNB, an en-gNB, or a 6G-NB; and
each of the plurality of 3GPP access paths uses a RAT of at least one of a E-UTRA, a NR, 3GPP RAT or a 6G radio technology.

8. The core network node of claim 1, wherein the sending, to the policy control node, the first policy session message is further based on address information of one or more policy control nodes supporting the dualsteer.

9. The core network node of claim 2, wherein the instructions further cause the core network node to determine to send the first policy session message based on receiving, from the wireless device, a non-access stratum (NAS) message indicating at least one of:
registration of the second 3GPP access path of the plurality of 3GPP access path;
deregistration of the first 3GPP access path from the plurality of 3GPP access path;
a change of first tracking area of the first 3GPP access path;
a change of a network slice registered for the first 3GPP access path;
a change of a RAT of the first 3GPP access path;
unavailability of the first 3GPP access path;
a change of second tracking area of the second 3GPP access path;
availability of the first 3GPP access path;
registration of the second 3GPP access path;
a data session request adding the second 3GPP access path;
deregistration of the first 3GPP access path;
a PDU session request releasing the second 3GPP access path;
an indication that the wireless device requests the PDU session configured for dualsteer; or
an indication that the wireless device supports a capability of the PDU session configured for dualsteer.

10. The core network node of claim 2, wherein the first policy session message further comprises at least one of:
the first 3GPP access path identifier;
the second 3GPP access path identifier;
information of the first 3GPP access path; or
information of the second 3GPP access path.

11. The core network node of claim 2, wherein the instructions further cause the core network node to receive, from the policy control node and in response to sending the first policy session message, one or more policy session response messages comprising at least one of:
a first policy information for the first 3GPP access path;
the first 3GPP access path identifier;
a second policy information for the second 3GPP access path;
the second 3GPP access path identifier;
one or more network slice policy information for the dualsteer;
a first mobility restriction information for the first 3GPP access path; or
a second mobility restriction information for the second 3GPP access path, wherein:
the first mobility restriction information indicates one or more RATs restricted for the first 3GPP access path, and
the second mobility restriction information indicates one or more RATs restricted for the second 3GPP access path.

12. The core network node of claim 2, wherein the instructions further cause the core network node to send, to the policy control node, a first wireless device location information of the first 3GPP access path and a second wireless device location information of the second 3GPP access path, wherein each of the first and second wireless device location information comprises at least one of:
cell information;
tracking area information;
RAT information; or
PLMN information.

13. The core network node of claim 1, wherein in the dualsteer, the wireless device establishes the plurality of 3GPP access paths, the wireless device supports concurrent registrations via the plurality of 3GPP access paths, or the wireless device uses resources via the plurality of 3GPP access paths of a network.

14. The core network node of claim 1, wherein:
each of the plurality of 3GPP access paths is of a 3GPP access type;
a plurality of access types comprising the 3GPP access type and a non- 3GPP access type;
a radio access network of the 3GPP access type comprises at least one of:
E-UTRAN;
NG-RAN; or
6G-RAN; and
the non-3GPP access type does not comprise the E-UTRAN, the NG-RAN, and the 6G-RAN.

15. The core network node of claim 1, wherein the core network node comprises at least one of:
a mobility management node;
a session management node;
an access and mobility management (AMF); or
a session management function (SMF).

16. The core network node of claim 1, wherein the instructions further cause the core network node to send, to the wireless device, a message indicating that a PDU session for the dualsteer is configured.

17. The core network node of claim 1, wherein the sending the first policy session message is based on:
receiving, from a mobility management node or a user plane function, an indication indicating that the 3GPP access path, of the plurality of 3GPP access path, becomes available or unavailable; and
the one or more conditions.

18. A wireless device comprising:
one or more processors; and
memory storing instructions that, when executed by the one or more processors, cause the wireless device to:
send, to a core network node, one or more first protocol data unit (PDU) session establishment requests for dualsteer, wherein:
in the dualsteer, the wireless device communicates with a network via a plurality of 3rd generation partnership project (3GPP) access paths; and
the plurality of 3GPP access paths comprises a first 3GPP access path and a second 3GPP access path;
determine that an event, of one or more events, occurs, wherein the event is that the first 3GPP access path, of the plurality of 3GPP access paths, becomes unavailable;
based on the determining, send, via the second 3GPP access path, one or more report messages indicating:
a first identifier indicating the event; and
a second identifier indicating the first 3GPP access path; and
receiving one or more PDU session modification messages.

19. The wireless device of claim 18, wherein, in the dualsteer, the wireless device supports concurrent registrations via the plurality of 3GPP access paths, or the wireless device uses resources via the plurality of 3GPP access paths.

20. The wireless device of claim 18, wherein the instructions further cause the wireless device to receive a message indicating that a PDU session for the dualsteer is configured.
